(19) United States
(12) Patent Application Publication
(10) Pub. No.: US 2026/0054171 A1
(43) Pub. Date: Feb. 26, 2026

(54) PLAYER CONTROLS IN A FULLY CONTROLLED CAMERA SYSTEM

(71) Applicant: Skydance Silicon Valley, LLC, Santa Monica, CA (US)

(72) Inventors: Jeremy Luke Isaak, Canada (CA); Blake Stephen Guest, Santa Monica, CA (US); Julian Anthony Beak, Santa Monica, CA (US); Amy Jeanne Hennig, Santa Monica, CA (US)

(73) Assignee: Skydance Silicon Valley, LLC, Santa Monica, CA (US)

(21) Appl. No.: 19/301,746

(22) Filed: Aug. 15, 2025

Related U.S. Application Data
(60) Provisional application No. 63/686,418, filed on Aug. 23, 2024.
(60) Provisional application No. 63/686,333, filed on Aug. 23, 2024.

(51) Int. Cl. A63F 13/5258; A63F 13/5252; A63F 13/79

(52) U.S. Cl. CPC A63F 13/5258; A63F 13/5252; A63F 13/79

(57) ABSTRACT

Embodiments described herein teach of systems and methods for managing player controls within a fully controlled camera system for an interactive environment. The system automatically renders camera views from different orientations, creating cinematic cuts without direct player input. In response to a cut from a first orientation to a second, the system establishes a new control scheme relative to the new view to maintain intuitive gameplay. A transition to the second control scheme can be delayed allowing the player to adapt. In some embodiments, the system evaluates player input to detect adaptation before applying the new scheme. In other embodiments, a transition timer, based on historical player telemetry data, dictates the delay. The system can also receive player hints via input devices, converting these hints into weights that influence the scoring of potential camera points, allowing the player to guide camera selection.

### PRIORITY

This application claims the benefit of, and priority to U.S. Provisional Application, entitled “Player Controls in a Fully Controlled Camera System,” filed on Aug. 23, 2024 and having application Ser. No. 63/686,384 and U.S. Provisional Application No. 63/686,333 filed Aug. 23, 2024, the entirety of each of said application being incorporated herein by reference.

### FIELD

The present disclosure relates to interactive games. More particularly, the present disclosure relates to managing player controls for a fully controlled camera system within an interactive game.

### BACKGROUND

In three-dimensional interactive games, the use of camera controls has been highly prevalent, as it allows players to navigate and interact with complex environments. Players typically use control sticks or mouse inputs to adjust the camera angle, ensuring they have a view of their surroundings and can respond to in-game challenges. However, in these traditional games where players control the game camera with, for example, a control stick, a common issue is that players spend significant amounts of time staring at the back of their main character. This setup often results in a detached experience, where the player feels like they are controlling a remote-controlled object rather than embodying the character they are playing. The constant rear view limits the sense of immersion, making it difficult for players to fully engage with the game world and the character's experiences.

Controlling a three-dimensional game camera can also present a steep learning curve, particularly for newer players who may struggle with the complexity of navigating and adjusting the camera. Unlike two-dimensional games where movement and perspective are straightforward, three-dimensional environments require players to manage an additional axis of control, often leading to disorientation and frustration. New players must learn to coordinate their character's movements with the camera's angle, ensuring they maintain a clear view of their surroundings while also responding to in-game challenges. This dual tasking can sometimes be overwhelming, as it involves mastering the use of control sticks or mouse inputs to achieve smooth and precise camera adjustments. Additionally, the sensitivity settings, inversion options, and various camera modes can add layers of complexity, making it difficult for inexperienced players to find a comfortable setup.

These challenges can detract from the enjoyment of the game, as players may spend more time wrestling with camera controls than engaging with the gameplay and story, potentially discouraging continued play and diminishing the overall gaming experience. These issues can create a psychological barrier for the player, reducing the emotional connection and sense of presence within the game. Instead of feeling like they are part of the action, players may feel more like observers, which can diminish the overall impact of storytelling and character development.

### SUMMARY OF THE DISCLOSURE

Systems and methods for managing player controls for a fully controlled camera system within an interactive game in accordance with embodiments of the disclosure are described herein. In some embodiments, a device includes a processor a memory communicatively coupled to the processor and a full control camera logic, stored in the memory and executed by the processor. The logic is configured to render a first camera within a scene of an interactive environment at a first orientation establish a first control scheme relative to the first orientation determine if a cut within the scene has occurred render, upon determining that a cut has occurred, a second camera within the scene at a second orientation and establish a second control scheme relative to the second orientation.

In some embodiments, the interactive environment is a video game environment.

In some embodiments, the scene is a unique portion of the video game environment.

In some embodiments, the full control camera logic is further configured to execute the video game environment upon establishing the first control scheme.

In some embodiments, the full control camera logic is further configured to execute the video game environment upon establishing the second control scheme.

In some embodiments, the full control camera logic is further configured to evaluate player input after establishing the second control scheme.

In some embodiments, the full control camera logic is further configured to determine if the evaluated player input indicates if a player has adapted to the second control scheme.

In some embodiments, the full control camera logic is further configured to continue, upon determining that the player has adapted to the second control scheme, the second control scheme.

In some embodiments, the full control camera logic is further configured to revert, upon determining that the player has not adapted to the second control scheme, to the first control scheme.

In some embodiments, the full control camera logic is further configured to re-determine if the evaluated player input indicates if a player has adapted to the second control scheme until an adaptation has occurred.

In some embodiments, the full control camera logic is further configured to execute the video game environment utilizing the second control scheme upon adaptation.

In some embodiments, a device includes a processor a memory communicatively coupled to the processor and a full control camera logic, stored in the memory and executed by the processor. The logic is configured to render a first camera within a scene of an interactive environment at a first orientation establish a first control scheme relative to the first orientation determine if a cut within the scene has occurred render, upon determining that a cut has occurred, a second camera within the scene at a second orientation initiate a transition timer and establish, upon expiration of the transition timer, a second control scheme relative to the second orientation.

In some embodiments, the full control camera logic is further configured to gather player data.

In some embodiments, the full control camera logic is further configured to parse player data to determine a historical adaptation time.

In some embodiments, the transition timer is configured based on at least the historical adaptation time.

In some embodiments, a method of establishing control schemes within an interactive environment includes rendering a first camera within a scene of the interactive environment at a first orientation establishing a first control scheme relative to the first orientation determining if a cut within the scene has occurred rendering, upon determining that a cut has occurred, a second camera within the scene at a second orientation and establishing a second control scheme relative to the second orientation.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a video game ecosystem in accordance with various embodiments of the disclosure;

FIG. 2 is a conceptual block diagram of a device suitable for configuration with a full control camera logic, in accordance with various embodiments of the disclosure;

FIG. 3 is an abstract block diagram of the components of a fully controlled camera system 300 in accordance with various embodiments of the disclosure;

FIG. 4 is an abstract block diagram of the data within a storage 318 of a fully controlled camera system in accordance with various embodiments of the disclosure;

FIG. 5 is a conceptual illustration of automatic relative movement control changes in accordance with various embodiments of the disclosure;

FIG. 6 is a conceptual illustration of utilizing player hints in camera selection weighting in accordance with various embodiments of the disclosure;

FIG. 7 is a flowchart of a process for utilizing relative control schemes in accordance with various embodiments of the disclosure;

FIG. 8 is a flowchart of a process for adapting a relative control scheme to a player in accordance with various embodiments of the disclosure;

FIG. 9 is a flowchart of a process for utilizing telemetry data in a relative control scheme in accordance with various embodiments of the disclosure; and

FIG. 10 is a flowchart of a process for utilizing player hints for camera score weighting in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the problems outlined above, embodiments of the disclosure described herein can utilize a fully controlled camera system in a game where the camera automatically switches between different angles during gameplay, unlike traditional games where players manually control the camera. This system can leverage various cinematographic principles to make these cuts occur and are perceived seamlessly, enhancing the cinematic quality of the game and maintaining immersion. In many embodiments, a goal is to create a gameplay experience that looks and feels like a movie, with dynamic camera angles and transitions that respond to the action in real-time.

In traditional games a single orbiting camera is often used that players can control, but embodiments described herein can integrate various heuristics and other processes to manage camera angles automatically, adhering to rules of cinema such as the 180-degree rule, avoiding jump cuts, and framing shots effectively. This approach can allow the game to maintain a cinematic feel even during intense combat scenes, making the gameplay look like a polished action movie.

The fully controlled camera system can be configured to keep players oriented and engaged by using screen-relative controls, meaning the direction the player moves is always consistent with what they see on screen, regardless of camera angle changes. This can reduce the learning curve and disorientation for players, allowing them to focus on the action rather than camera management. In many embodiments, an aim is to perfect the fully controlled camera system to the point where manual camera control is unnecessary, providing a seamless and intuitive experience that aligns with narrative and gameplay needs.

Control schemes, meaning how a player's actions on an input device affect the actions within the game environment can change dynamically in response to camera cuts. When the camera transitions from one perspective to another, the system can recalibrate the control inputs and the player can also recalibrate such that their player character's actions within the game remain consistent with their expectations. For example, if the camera cuts from a rear view to a side view, the direction in which the player pushes the control stick should adjust to that new direction as well. This recalibration process can often involve real-time or near real-time adjustments.

A well-implemented fully controlled camera system with dynamic control scheme adjustment can allow players to remain immersed in the game without having to consciously be mindful of how to adjust their inputs or reorient themselves after each camera cut. Often, this fluidity can be natural to players, even during high-action sequences or complex maneuvers, where consistent control is vital for maintaining gameplay flow and enjoyment.

However, there may be times when a player does not immediately adjust to a new control scheme. In this instances, a delay or pause in the control scheme change can occur. In some embodiments, the new control scheme may not be applied until the system detects that the player has changed their input patterns to correspond to the new control scheme. In additional embodiments, telemetry data or other historical data associated with the player can be used to generate a lag or delay in applying new control schemes. In this way, a seamless experience can be achieved, even if the player is not reacting instantaneously.

Finally, in various embodiments, the player or players can provide hints or indications that they desire to have the camera switch to a specific location within the game environment. While a fully controlled camera system may not have a direct override button or control, these hints can be utilized to weigh or otherwise influence the scores generated for each of the available camera points in an environment such that the “desired” camera view is still selected, thus providing players with satisfaction during gameplay.

A fully controlled camera system, in the context of an interactive environment, may refer to a system that automates all aspects of camera positioning, movement, and shot selection without requiring direct control from a player. Such a system can be designed to emulate the techniques of a film director and cinematographer, utilizing a network of predefined camera points within a scene and selecting between them based on real time analysis of gameplay, narrative context, and established cinematic principles. The primary goal of this system is to create a dynamic, visually engaging, and movie like experience for the player, freeing them from the task of manual camera management and enhancing their immersion in the game world.

Within the embodiments described herein, the fully controlled camera system (300) is not only a tool for visual presentation but also a core component of the gameplay and control experience. The system can be composed of multiple interacting logics, such as a virtual editor logic (340) for deciding when to cut, a virtual cinematographer logic (342) for selecting aesthetically pleasing shots, and a virtual cameraman logic (344) for simulating realistic camera movements. Critically, this system works in concert with a dynamic control scheme, ensuring that every time the camera cuts to a new perspective, the player's controls are automatically and intuitively remapped relative to that new orientation, thereby maintaining a seamless and unbroken connection between the player's intentions and the character's actions on screen.

A control scheme can be understood as the defined mapping between a player's physical inputs on an interface device, such as a game controller, and the corresponding actions or movements performed by a character or object within an interactive environment. This mapping dictates how specific inputs, for instance the movement of a joystick or the press of a button, are interpreted by the game engine to produce outcomes like character locomotion, attacks, or interactions with the environment. A well-designed control scheme is typically intuitive and consistent, allowing the player to operate within the game world with minimal cognitive load.

In the context of the present disclosure, a control scheme is specifically established as being relative to the camera's current orientation. This means the control mapping is not fixed but is instead dynamically recalibrated each time the fully controlled camera system executes a cut to a new viewpoint. For example, when a first control scheme is active, pushing “forward” on a control stick moves the character in the direction that appears forward from the first camera's perspective. Upon a cut to a second camera with a different orientation, a second control scheme is established that remaps the inputs, ensuring that pushing “forward” still moves the character in the on-screen forward direction, thereby providing a consistent and non-disorienting experience for the player.

A cut, in a cinematographic sense, refers to an instantaneous transition from one camera shot to another, creating an immediate change in perspective, location, or time. In the context of a three-dimensional interactive game, a cut can be defined as an automated and abrupt switch from the viewpoint of a first virtual camera to the viewpoint of a second virtual camera within a scene. This transition is distinct from continuous camera movements like panning or zooming, as it does not render the intervening space or motion between the two camera positions, instead presenting a direct change of view.

As described in various embodiments, determining if a cut has occurred involves a systematic evaluation by a virtual editor logic. A cut point may be triggered by a variety of conditions, including predefined gameplay events, the player character crossing a spatial threshold, or the system's ongoing analysis of camera scores. Each available camera point in a scene may be assigned a score based on factors like framing, visibility of key objects, and adherence to cinematic heuristics. A cut may occur when the score of an alternative camera point significantly surpasses the score of the currently active camera, prompting the system to transition to the higher scoring viewpoint to enhance the narrative impact or gameplay clarity.

Telemetry data generally refers to the automated collection and transmission of data from remote or distributed sources to a central receiving system for monitoring and analysis. In the field of interactive software and video games, telemetry data typically involves gathering a wide range of information related to player behavior, in game events, and system performance during active gameplay sessions. This data is often collected in an anonymized fashion from a large player base to provide developers with insights into how the game is being played.

Within the framework of the present disclosure, telemetry data is more specifically utilized to gather information regarding a player's adaptation to dynamic changes in control schemes. This can include collecting and analyzing historical adaptation data, which quantifies the amount of time a player typically takes to adjust their physical inputs to align with a new control scheme following an automated camera cut. This telemetry data can be specific to an individual player's history or aggregated across many players to establish a general baseline. The system can then use this data to configure a transition timer, personalizing the delay before a new control scheme is applied to better match the player's learned rhythm and improve the overall fluidity of the gameplay experience.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C. ”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

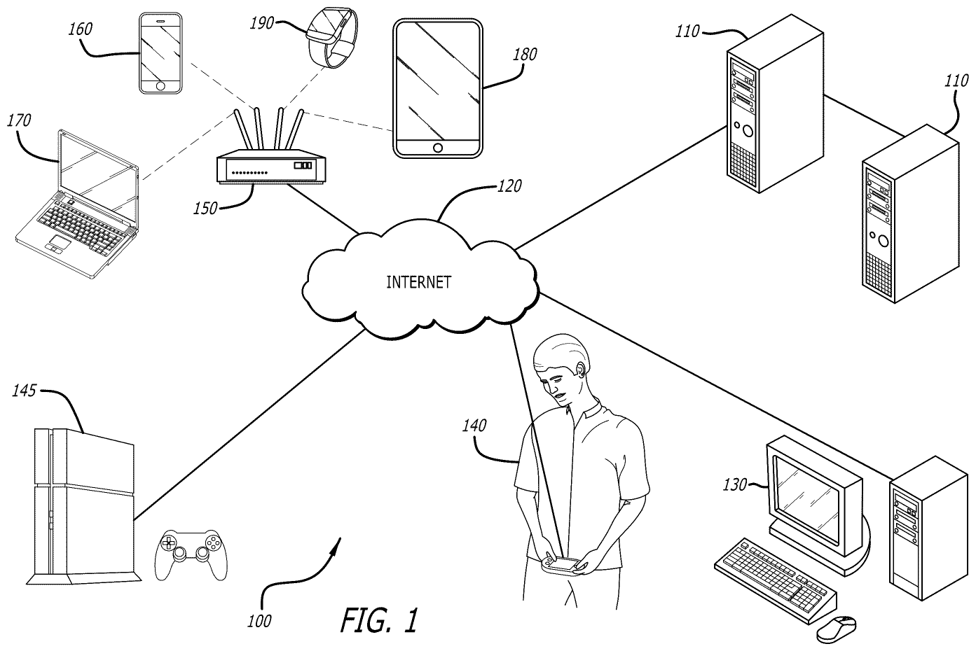

Referring to FIG. 1, a video game ecosystem 100 in accordance with various embodiments of the disclosure is shown. In many embodiments, the game can be designed to seamlessly integrate and function across various devices, including servers 110, home gaming consoles 145, mobile gaming consoles 140, laptops 170, personal computers 130, tablets 180, smartphones 160, wearable devices 190, and more. This integration can ensure a consistent and optimized gaming experience, regardless of the device being used.

In some embodiments, the game can be developed using a modular architecture, enabling compatibility and scalability across multiple platforms. The core game logic, assets, and the camera system may be abstracted into platform-agnostic modules. These modules can be encapsulated in a game engine designed to handle platform-specific requirements dynamically. As those skilled in the art will recognize, certain embodiments, such as games that require a client/server relationship may require one or more aspects of the game to be processed server-side in one or more of the servers 110.

In a number of embodiments, distribution of the game across the various platforms may leverage cloud-based infrastructure, enabling seamless delivery of game content to end-users. Upon release, the game can be hosted on central servers 110 equipped with, or working in conjunction with, content delivery networks (CDNs) to minimize latency and ensure quick access. Players may download the game client tailored to their specific device. For home gaming consoles and personal computers, distribution can be through established digital storefronts, such as the PlayStation Network, Xbox Live, Steam, and others. Mobile and tablet versions may be available via app stores like Google Play and Apple's App Store. Additionally, wearable devices and newer platforms can access the game through dedicated portals or companion apps.

In various embodiments, upon installation, the game may communicate with central servers 110 to authenticate users, sync progress, and manage in-game assets. In some embodiments, for instance, on higher-performance home gaming consoles 145 and PCs 130, the game may provide high-resolution, dynamic range views with advanced effects like depth of field and motion blur. On mobile devices and tablets, the camera system can optimize for performance, ensuring smooth gameplay while maintaining visual fidelity.

Certain embodiments of the ecosystem 100 may allow for cross-platform play, allowing users to interact and play together regardless of the device they are using. This architecture can support this by maintaining a unified player database and real-time synchronization of game states. In various embodiments, the camera system can adjust its parameters, scores, or views based on the device in use or the current state of other players within the online game, ensuring a consistent gameplay experience.

In more embodiments, updates can be distributed through the same channels as the original game, ensuring that all devices receive the latest features, bug fixes, and improvements simultaneously. The fully controlled camera system and any associated logic, being a part of the gameplay experience, may also receive regular updates and telemetry data to enhance functionality and performance based on user feedback and advancements in technology.

In additional embodiments, the ecosystem 100 can include one or more servers 110 that can play a role in ensuring smooth operation, synchronization, and management of the game across various devices. The server 110 can be configured to handle various operations such as, but not limited to, user authentication, ensuring that only legitimate users can access the game. This process may involve verifying login credentials and managing user sessions. Additionally, the server 110 can manage authorization, determining what resources and features each user is permitted to access based on their account type and progress within the game.

In further embodiments, the server 110 can maintain the game's overall state, ensuring consistency and synchronization across all connected devices. This may involve tracking player progress, in-game events, and real-time interactions. For multiplayer scenarios, the server 110 can ensure that all players experience the same game state, coordinating actions and updates to maintain a seamless multiplayer experience.

In still more embodiments, servers 110 can be responsible for delivering game content, including initial game files, updates, patches, and downloadable content (DLC). They may utilize content delivery networks (CDNs) to distribute these files efficiently, reducing latency and ensuring that players can quickly access and download necessary game data. In multiplayer games, the server 110 can manage matchmaking, pairing players based on their skill levels, preferences, and other criteria. Once matched, the server 110 may establish and manage game sessions, ensuring that players are connected to the appropriate game instances and maintaining the integrity of these sessions.

The server 110 may also be configured to store and manages all necessary game data, including user profiles, game progress, leaderboards, and in-game statistics. This data can be stored in secure databases and accessed and updated as needed to reflect players' actions and achievements within the game. To maintain a fair gaming environment, various embodiments of the server 110 can implement security measures and anti-cheat systems. These measures can be configured to detect and prevent unauthorized modifications, hacks, or exploits that could disrupt the game's balance or give certain players unfair advantages.

Servers 110 can also collect and analyze data related to game performance, user behavior, and system health. This information may be used to monitor the game's performance, identify and address issues, and inform future updates and improvements. Analytics can also help in understanding player engagement and preferences, guiding the development of new features and content. In yet additional embodiments, the server 110 can facilitate social features, such as friend lists, messaging, and in-game communities. It can sometimes manage interactions between players, supports communication channels, and ensures that social features are integrated seamlessly into the gaming experience. To handle varying numbers of concurrent players, the server 110 can be designed to have a scalable infrastructure. This may include utilizing load balancing techniques to distribute the workload evenly across multiple servers, ensuring consistent performance and preventing any single server from becoming a bottleneck.

In many embodiments, the ecosystem 100 may utilize the internet 120 and wireless network devices like routers 150 to efficiently deliver data across various devices, ensuring seamless connectivity and gameplay. For wireless devices, such as mobile gaming consoles 140, tablets 180, and wearable devices 190, the router 150 can provide Wi-Fi connectivity. Modern routers support high-speed wireless standards like Wi-Fi 6, which offer faster data rates, lower latency, and improved handling of multiple devices simultaneously. This can ensure a stable and efficient connection for gaming, even in households with numerous connected devices.

As the game operates, data packets are transmitted between the player's device and the servers 110. These packets may include user inputs, game state updates, and synchronization data. The router 150 can handle the routing of these packets, directing them to their destination through the internet. Advanced Quality of Service (QoS) settings on routers can prioritize gaming traffic to ensure minimal latency and reduced lag, enhancing the gaming experience. During multiplayer sessions, the router 150 can play a role in maintaining a stable connection. It manages data traffic between multiple players, ensuring that game state updates and player interactions are synchronized in real-time. The ecosystem 100 can also be configured to utilize peer-to-peer (P2P) networking in conjunction with traditional client-server models. In P2P setups, game data may be shared directly between players'devices, reducing the load on central servers and improving data transfer speeds. The router 150 can, in certain embodiments, facilitate these direct connections, ensuring that data packets are correctly routed between peers.

In a number of embodiments, a PC 130 can download the game/game client from a digital storefront from one or more servers 110. Once installed, the game client can connect to the game's servers 110 via the internet 120, authenticating the user and syncing their game data. In certain embodiments, the PC 130 can also interact with other devices in the ecosystem 100. For example, a player might use a mobile app on their tablet 180 or smartphone 160 to manage their game inventory or chat with friends while playing on their PC 130. These interactions can be facilitated by one or more servers 110, which can synchronize data across all connected devices, ensuring a unified and cohesive gaming experience.

As those skilled in the art will recognize, home gaming consoles 145 are often specifically designed for gaming, providing a consistent and optimized experience without the need for extensive configuration. In various embodiments, home gaming consoles 145 frequently include social and community features that are tightly integrated into the ecosystem 100. Players can easily add friends, join parties, and communicate through voice or text chat. Additionally, game content distribution on home gaming consoles 145 often involves digital storefronts. In additional embodiments, consoles are designed to work seamlessly with various peripherals and accessories, such as controllers, headsets, and virtual reality (VR) devices.

In further embodiments, a mobile gaming console 140 has a design emphasizing portability, featuring a compact form factor, built-in display, and rechargeable battery. This allows players to continue their gaming sessions seamlessly when moving between different locations. In various embodiments, the game client and associated game logic on the mobile gaming console is optimized to handle the specific hardware and connectivity characteristics of these devices, ensuring smooth performance and efficient battery usage.

The mobile gaming console 140 can also connect to other devices through companion apps or cloud gaming services. For example, a player might use a mobile app on their console 140 to manage in-game items or communicate with friends, synchronizing this data with their main game profile on the servers 110. In certain embodiments, cloud gaming services can allow the mobile gaming console 140 to stream games from powerful servers 110, bypassing the need for high-end local hardware and ensuring access to graphically intensive games that would otherwise be beyond the device's capabilities.

Furthermore, mobile gaming consoles 140 can often support local multiplayer gaming through ad-hoc networks or Bluetooth connections. This may allow players to connect directly with other nearby mobile gaming consoles 140 for shared gaming experiences without relying solely on the internet. The servers 110 can then sync any local multiplayer progress with the broader ecosystem 100 once the devices reconnect to the internet 120.

Unlike stationary PCs 130, laptops 170, can be used in various environments, from home to public spaces. Many gaming laptops 170 come with dedicated GPUs, allowing for high-quality graphics and smooth gameplay. Laptops 170 may also support various peripheral connections, including external displays, gaming controllers, and VR headsets, expanding their gaming capabilities.

In more embodiments, smartphones 160 can offer unique features like GPS, accelerometers, gyroscopes, and cameras, which can be integrated into gameplay to provide augmented reality (AR) experiences and location-based gaming. Touchscreens are often standard on smartphones 160, facilitating intuitive controls and gestures. The ubiquity of smartphones 160 can ensure that players can engage with the game ecosystem wherever they are, and mobile-specific features like notifications keep players connected to in-game events and updates. Additionally, smartphones 160 may often include biometric security features such as fingerprint scanners and facial recognition, enhancing secure access to game accounts and in-game purchases.

In numerous embodiments, wearable devices 190, such as, but not limited to, smartwatches and AR glasses, can add a layer of interaction that extends beyond traditional gaming platforms. These devices can provide real-time notifications, health tracking, and context-sensitive interactions based on the player's environment. For example, a smartwatch might track physical activity during a fitness game, providing feedback and integrating physical activity into the gaming experience. In another example, AR glasses can overlay game elements onto the real world, creating immersive and interactive experiences that blend reality with the virtual game environment. Wearable devices 190 may also enable continuous engagement with the ecosystem 100 through haptic feedback and voice commands, allowing players to interact without needing to look at a screen.

In still more embodiments, tablets 180 can offer a larger screen size than smartphones while maintaining portability, making them ideal for immersive gameplay on the go. Tablets 180 may be configured to support both touch and stylus input, providing precise control options for games that require fine-tuned interactions. They may also be excellent for split-screen or multi-window functionality, enabling players to run multiple apps simultaneously, such as a game and a companion app. Tablets 180 can easily connect to external peripherals like keyboards and game controllers, bridging the gap between mobile and traditional gaming setups.

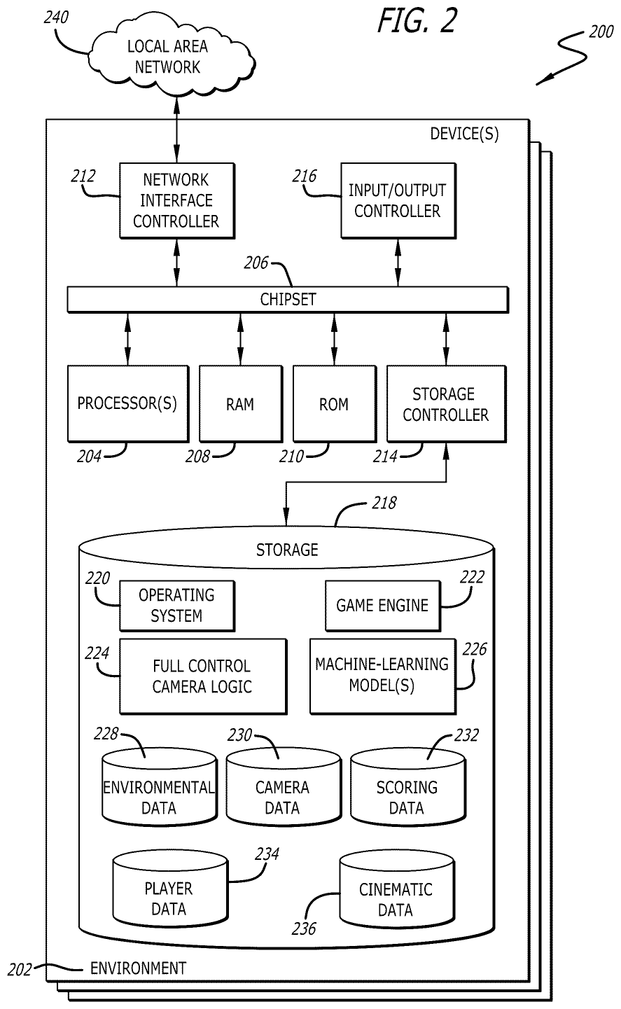

Although a specific embodiment for a video game ecosystem 100 is described above with respect to FIG. 1, any of a variety of systems and/or processes may be utilized in accordance with embodiments of the disclosure. For example, the video game ecosystem 100 may be configured into any number of various network topologies including different types of interconnected devices and user devices. The elements depicted in FIG. 1 may also be interchangeable with other elements of FIG. 2-10 as required to realize a particularly desired embodiment.

Referring to FIG. 2, a conceptual block diagram of a device 200 suitable for configuration with a full control camera logic 224, in accordance with various embodiments of the disclosure is shown. The embodiment of the conceptual block diagram depicted in FIG. 2 can illustrate a conventional game device, personal computer, mobile game device, game server, laptop, tablet, network appliance, e-reader, smartphone, wearable device, or other computing device, and can be utilized to execute any of the application and/or logic components presented herein. The device 200 may, in many non-limiting examples, correspond to physical devices or to virtual resources described herein.

In many embodiments, the device 200 may include an environment 202 such as a baseboard or “motherboard,” in physical embodiments that can be configured as a printed circuit board with a multitude of components or devices connected by way of a system bus or other electrical communication paths. Conceptually, in virtualized embodiments, the environment 202 may be a virtual environment that encompasses and executes the remaining components and resources of the device 200. In more embodiments, one or more processors 204, such as, but not limited to, central processing units (“CPUs”) can be configured to operate in conjunction with a chipset 206. The processor(s) 204 can be standard programmable CPUs that perform arithmetic and logical operations necessary for the operation of the device 200.

In a number of embodiments, the processor(s) 204 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 206 may provide an interface between the processor(s) 204 and the remainder of the components and devices within the environment 202. The device 200 can incorporate different types of processors to enhance performance and efficiency across various tasks. A central processing unit (CPU) can handle primary processing tasks such as game logic, AI, and player inputs, while a graphics processing unit (GPU) can be specialized for rendering high-resolution graphics and visual effects. Digital signal processors (DSPs) may manage audio processing, delivering high-quality sound without burdening the CPU. In portable devices, systems on a chip (SoCs) can be configured to integrate the CPU, GPU, memory, and peripherals to balance performance and efficiency. In some embodiments, application-specific integrated circuits (ASICs) can optimize specific functions like cryptographic processing, while neural processing units (NPUs) accelerate AI and machine learning tasks. Some high-end devices may also include physics processing units (PPUs) to handle complex physics calculations, further enhancing the realism and responsiveness of the gaming experience. However, those skilled in the art will recognize that the device 200 can any variety or combination of processor(s) 204 as needed to satisfy the desired application.

The chipset 206 can provide an interface to a random-access memory (“RAM”) 208, which can be used as the main memory in the device 200 in some embodiments. The chipset 206 can further be configured to provide an interface to a computer-readable storage medium such as a read-only memory (“ROM”) 210 or non-volatile RAM (“NVRAM”) for storing basic routines that can help with various tasks such as, but not limited to, starting up the device 200 and/or transferring information between the various components and devices. The ROM 210 or NVRAM can also store other application components necessary for the operation of the device 200 in accordance with various embodiments described herein.

Additional embodiments of the device 200 can be configured to operate in a networked environment using logical connections to remote computing devices and computer systems through a network, such as the local area network 240. The chipset 206 can include functionality for providing network connectivity through a network interface controller (“NIC”) 212, which may comprise a gigabit Ethernet adapter or similar component. The NIC 212 can be capable of connecting the device 200 to other devices over the local area network 240. It is contemplated that multiple NICs 212 may be present in the device 200, connecting the device to other types of networks and remote systems, such as the Internet.

In further embodiments, the device 200 can be connected to a storage 218 that provides non-volatile storage for data accessible by the device 200. The storage 218 can, for instance, store an operating system 220, and/or game engine 222. In various embodiments, the storage 218 can be connected to the environment 202 through a storage controller 214 connected to the chipset 206. In certain embodiments, the storage 218 can consist of one or more physical storage units. The storage controller 214 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

In additional embodiments, the device 200 can store data within the storage 218 by transforming the physical state of the physical storage units to reflect the information being stored. The specific transformation of physical state can depend on various factors. Examples of such factors can include, but are not limited to, the technology used to implement the physical storage units, whether the storage 218 is characterized as primary or secondary storage, and the like.

In many more embodiments, the device 200 can store information within the storage 218 by issuing instructions through the storage controller 214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. In some embodiments, the device 200 can further read or access information from the storage 218 by detecting the physical states or characteristics of one or more particular locations within the physical storage units.

In addition to the storage 218 described above, certain embodiments of the device 200 may also have access to other computer-readable storage media to store and retrieve information, such as program modules, data structures, or other data. It should be appreciated by those skilled in the art that computer-readable storage media is any available media that provides for the non-transitory storage of data and that can be accessed by the device 200. In some examples, operations performed by a cloud computing network, and or any components included therein, may be supported by one or more devices similar to device 200. Stated otherwise, some or all of the operations performed by the cloud computing network, and or any components included therein, may be performed by one or more devices 200 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 218 can store an operating system 220 utilized to control the operation of the device 200. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 218 can store other system or application programs and data utilized by the device 200.

In many additional embodiments, the storage 218 or other computer-readable storage media is encoded with computer-executable instructions which, when loaded into the device 200, may transform it from a general-purpose computing system into a special-purpose computer capable of implementing the embodiments described herein. These computer-executable instructions may be stored as application and transform the device 200 by specifying how the processor(s) 204 can transition between states, as described above. In some embodiments, the device 200 has access to computer-readable storage media storing computer-executable instructions which, when executed by the device 200, perform the various processes described above with regard to FIGS. 1 and 3-10. In certain embodiments, the device 200 can also include computer-readable storage media having instructions stored thereupon for performing any of the other computer-implemented operations described herein.

In a number of embodiments, the device 200 can store a game engine 222 in storage 218 and load it when the game is launched, enabling quick access and execution. The game engine 222 can manage core tasks such as rendering graphics, processing inputs, handling physics calculations, and managing audio by leveraging the device's CPU, GPU, and other hardware components. It can abstract hardware complexities to ensure smooth gameplay and real-time interaction. Additionally, in various embodiments, the game engine 222 cam facilitate network communications for multiplayer interactions and supports cross-platform functionality, allowing games to run efficiently on various devices within the available game ecosystem.

In many further embodiments, the device 200 may include a full control camera logic 224. The full control camera logic 224 can be configured to perform one or more of the various steps, processes, operations, and/or other methods that are described above. Often, the full control camera logic 224 can be a set of instructions stored within a non-volatile memory that, when executed by the processor(s)/controller(s) 204 can carry out these steps, etc. In some embodiments, the full control camera logic 224 may be a client application that resides on a network-connected device, such as, but not limited to, a server, switch, personal or mobile computing device in a single or distributed arrangement.

To further elaborate on the full control camera logic 224, this component can serve as the central processing hub for executing the core functions recited in the claims. It may be configured to directly interface with the game engine 222 to render the first and second cameras at their respective orientations within a scene. The logic can also be responsible for establishing the first and second control schemes by dynamically creating or modifying the input maps used by the input output controller 216 to interpret player actions relative to the current camera's viewpoint. Furthermore, the full control camera logic 224 can continuously analyze scoring data 232 and cinematic data 236 to determine in real time if a cut has occurred, thereby triggering the entire transition process.

In some embodiments, environmental data 228 can comprise various sub-data types point of interest data, environmental dimension data, play area data, and/or camera location data. In various embodiments, point of interest data can be utilized to highlight key objects or characters that the camera should focus on, ensuring that important elements are always in view. Environmental dimension data may provide the spatial parameters of the game environment that is being evaluated and/or rendered, allowing the camera to navigate and position itself accurately within that three-dimensional space. Play area data can be configured to define the boundaries and active regions where the player can move and/or gameplay can occur, helping the camera maintain optimal angles. Camera location data may include information about the current and potential positions of the camera, enabling dynamic adjustments to provide the best perspectives and avoid obstacles.

In various embodiments, player data 234 can comprise player type data as player movement data, among others. Player type data can be configured to describe one or more attributes related to the player and their current avatar or move set. For example, a player may have either a short-range attack or a long-range attack, which can be captured within the player type data. Similarly, play movement data may allow for the capture of characteristics to how the player may be able to move within a given game environment (running, walking, jumping abilities, etc.).

The player data 234, in addition to containing player type and movement information, can be instrumental in managing control scheme transitions. In certain embodiments, this data store can be configured to record and maintain historical adaptation times for the player. For instance, after each camera cut, the system may measure the duration between the rendering of the second camera, and the moment the player's input aligns with the second control scheme. This duration can be stored as a data point within the player data 234. Over time, an aggregation of these data points can be parsed to determine an average or context specific historical adaptation time, which can then be used to configure a transition timer as claimed.

In more embodiments, camera data 230 may be utilized by a fully controlled camera system to facilitate the automatic management of camera movements for enhancement of the player's experience without requiring manual input. In some embodiments, the camera data 230 may comprise lens data for capturing information about focal length, aperture, depth of field, and the like, suitable for simulating real-world camera effects. Movement data can track and capture the camera's position and motion through the game environment. Base score data can include a base line score that each camera starts from when calculating a score for virtual editing. Framing data can ensures that key elements and characters are appropriately centered and visible within the frame. Camera type data may be configured to define the specific camera model or style being simulated, such as a handheld, Steadicam, cinematic, camcorder, drone camera, etc. Cameraman data can simulate or describe any human-operated camera movements, noise, or attributes to simulate a human camera operator, adding a layer of realism by mimicking how a person would handle the camera. Finally, camera weight data can account for the physical characteristics of the camera, influencing its inertia and how it responds to movements, contributing to a more authentic visual experience.

In further embodiments, scoring data 232 can include various sub-types of data including, but not limited to framing score data, player preference data, and update data. Framing score data can include various weights and items that can be utilized when generating a score for an associated camera point within a game environment. In some embodiments, player preference data can include data associated with one or more known player preferences, which can be captured from previous or historical gameplay, or “hints” provided to the game system, such as controller interactions. Finally, update data may provide one or more modifications to the weights utilized in one or more cameras or camera points when generating a score. For example, a certain camera within a game environment may never be selected due to the initial configuration of weights. Update data may allow for the modification of those weights such that the camera becomes a viable option for automatic cutting.

In still more embodiments, cinematic data 236 can include various heuristic data and telemetry data. As described in more detail below, heuristic data can include one or more heuristics associated with various cinematography or photography practices. In some embodiments, the heuristic data can be manually fine-tuned for a specifically desired game experience. However, as games are released and played by various players, telemetry data may be generated that gathers and otherwise transmits data related to various playthroughs done by players. In this way, the telemetry data can be used to update the game as desired by the game designers. For example, the telemetry data may indicate that players largely miss finding a particular hidden item in a gaming environment because a certain camera point is never selected. Utilizing this telemetry data, updates to the weights of the cameras within that gaming environment can be deployed such that more players may find that hidden item in the game.

In still further embodiments, the device 200 can also include one or more input/output controllers 216 for receiving and processing input from a number of input devices, such as a keyboard, a mouse, a touchpad, a touch screen, an electronic stylus, or other type of input device. Similarly, an input/output controller 216 can be configured to provide output to a display, such as a computer monitor, a flat panel display, a digital projector, a printer, or other type of output device. Those skilled in the art will recognize that the device 200 might not include all of the components shown in FIG. 2 and can include other components that are not explicitly shown in FIG. 2 or might utilize an architecture completely different than that shown in FIG. 2.

As described above, the device 200 may support a virtualization layer, such as one or more virtual resources executing on the device 200. In some examples, the virtualization layer may be supported by a hypervisor that provides one or more virtual machines running on the device 200 to perform functions described herein. The virtualization layer may generally support a virtual resource that performs at least a portion of the techniques described herein.

Finally, in numerous additional embodiments, data may be processed into a format usable by one or more machine-learning models 226 (e.g., feature vectors), and or other pre-processing techniques. The machine-learning (“ML”) models 226 may be any type of ML model, such as supervised models, reinforcement models, and/or unsupervised models. The ML models 226 may include one or more of linear regression models, logistic regression models, decision trees, Naïve Bayes models, neural networks, k-means cluster models, random forest models, and/or other types of ML models 226.

The ML model(s) 226 can be configured to generate inferences to make predictions or draw conclusions from data. An inference can be considered the output of a process of applying a model to new data. This can occur by learning from at least the environmental data 228, the camera data 230, the scoring data 232, the player data 234 and/or the cinematic data 236. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a set of coordinates within a three-dimensional space, a probability distribution, a set of labels/characteristics/parameters, a decision about an action to take, etc. Ground truth for the ML model(s) 226 may be generated by human/administrator verifications or may compare predicted outcomes with actual outcomes.

Although a specific embodiment for a device suitable for configuration with the full control camera logic suitable for carrying out the various steps, processes, methods, and operations described herein is discussed with respect to FIG. 2, any of a variety of systems and/or processes may be utilized in accordance with embodiments of the disclosure. For example, the device 200 may be in a virtual environment such as a cloud-based game administration environment, or it may be distributed across a variety of network devices or servers. The elements depicted in FIG. 2 may also be interchangeable with other elements of FIGS. 1 and 3-10 as required to realize a particularly desired embodiment.

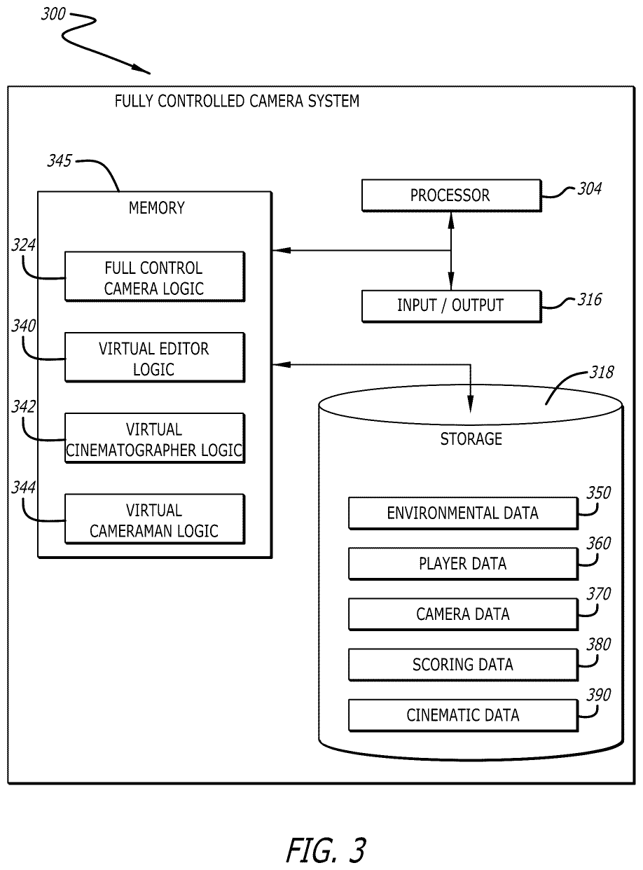

Referring to FIG. 3, an abstract block diagram of the components of a fully controlled camera system 300 in accordance with various embodiments of the disclosure is shown. In many embodiments, the fully controlled camera system 300 can be configured to include at least one or more processors 304, input/output functionality 316, a storage 318 as well as a memory 345 configured for executing one or more various logics. Specifically in the embodiment depicted in FIG. 3, the memory 345 comprises a full control camera logic 324 as well as a virtual editor logic 340, virtual cinematographer logic 342, and a virtual cameraman logic 344. Similarly, the storage 318 may comprise environmental data 350, player data 360, camera data 370, scoring data 380, and cinematic data 390.

In some embodiments, the full control camera logic 324 can facilitate the use of a camera system within a video game that is fully controlled by the system without input from the player. In certain embodiments, the full control camera logic 324 can work in conjunction with various other logics, such as a virtual editor logic 340, virtual cinematographer logic 342 and virtual cameraman logic 344. These logics may be configured as separate logics or may be interconnected or packaged/executed as a single logic.

In many embodiments, a virtual editor logic 340 in a fully controlled camera system 300 may consist of heuristics and rules designed to automatically adjust camera settings and movements to optimize the visual presentation of the game. This logic can analyze real-time game data and predefined criteria to make dynamic decisions about camera angles, transitions, and framing. Components of this analysis may include scene analysis, where the system evaluates the current context, such as the position of characters, action intensity, and environmental features, and the like. It could then use this analysis to choose the most appropriate camera angle and movement style, ensuring that important actions and details are highlighted effectively. In certain embodiments, this analysis may be done by evaluating different scores attached or otherwise associated with each available camera point within a gaming environment.

The virtual editor logic 340 can be the specific component within the fully controlled camera system 300 responsible for executing the claimed step of determining if a cut has occurred. This logic may continuously ingest real time environmental data 350 and player data 360 to understand the current game state. It can then apply rules from the cinematic data 390 to the scoring data 380 associated with all available camera points in a scene. A cut may be determined to have occurred when the virtual editor logic 340 calculates that the score of an inactive camera point has surpassed the score of the currently active camera point by a predefined threshold, signaling an optimal moment for a perspective shift.

In a number of embodiments, a virtual cinematographer logic 342 may consist of heuristics and decision-making processes designed to simulate the artistic choices made by a human cinematographer. The virtual cinematographer logic 342 may, in various embodiments, analyze real-time game data and pre-defined cinematic rules to automatically control camera angles, movements, and transitions, enhancing the storytelling and gameplay experience. This logic may incorporate various data inputs, such as lens data, movement data, base score data, framing data, camera type data, cameraman data, and camera weight data, to create visually appealing and contextually appropriate scenes.

In more embodiments, the virtual cinematographer logic 342 can dynamically adjust the camera or selection of a pre-established camera point based on in-game events, character actions, and environmental cues. For example, it could switch to a close-up during a dramatic dialogue, pan to follow a fast-moving character, or adopt a wide-angle shot to showcase expansive landscapes or other points of interest. In further embodiments, the virtual cinematographer logic 342 may also account for cinematic techniques such as rule of thirds, leading lines, and depth of field to ensure aesthetically pleasing compositions. Additionally, this logic would manage transitions between different camera angles and movements smoothly, maintaining continuity and immersion.

In yet more embodiments, a virtual cameraman logic 344 may comprise a set of heuristics and rules designed to mimic the decisions, sounds, and movements of a human cameraman, creating a dynamic and immersive visual experience. This logic can process various types of camera data 370, such as lens settings, movement parameters, and framing preferences, to determine the best camera angles and transitions in real-time. In certain embodiments the virtual cameraman logic 344 may utilize the game's context, such as the player's actions, environmental changes, and narrative elements, to adjust the camera's position and orientation realistically.

The virtual cameraman logic 344 may also incorporate elements like camera type and cameraman data to simulate different styles of camera work, such as steady shots, handheld movements, or dramatic zooms and pans. Additionally, certain embodiments of the virtual cameraman logic 344 can evaluate can incorporate sounds and other action or indications that a real person is behind the game camera, increasing the overall level of realism within the game scene.

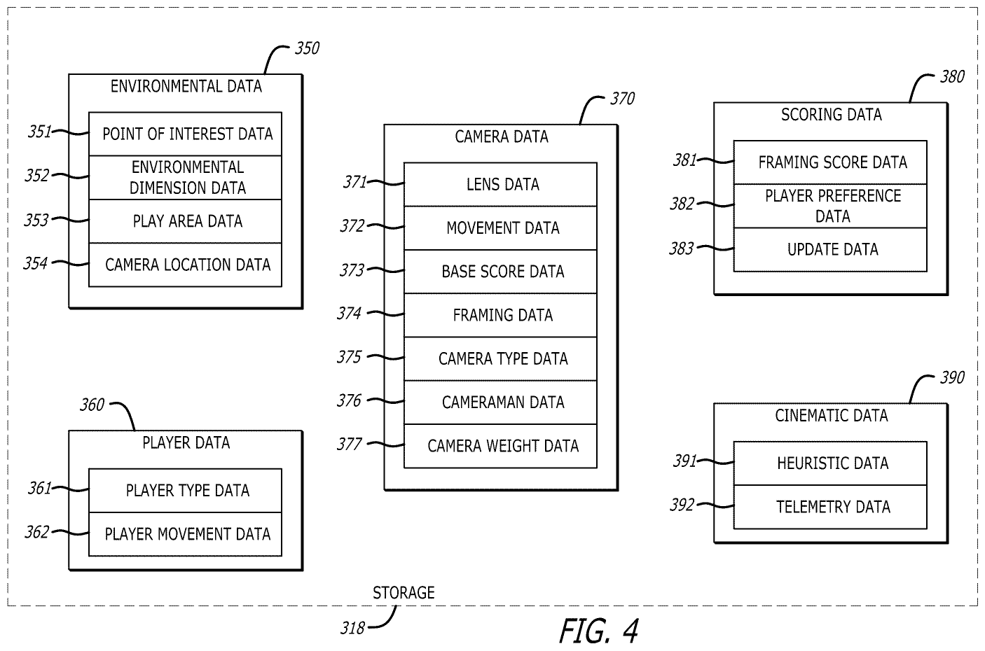

As discussed above in the embodiment depicted in FIG. 2, and in more detail below in the embodiment depicted in FIG. 4, the fully controlled camera system 300 may include a number of different types of available data to work with. These data may include environmental data 350 that can capture various aspects of the gaming environment being rendered and utilized. There may also be player data 360 that can describe different attributes of the player and their current avatar. Camera data 370 can be configured to provide various types of information related to how a camera may be set up, moved, and selected within a gaming environment. Scoring data 380 can help guide the system to determine what the correct or optimal score would be for each camera. Finally, cinematic data 390 can provide any specific heuristic or telemetry data that can better indicate what camera would be best be selected in a fully controlled camera system 300.

Although a specific embodiment for an abstract block diagram of the components of a fully controlled camera system 300 suitable for carrying out the various steps, processes, methods, and operations described herein is discussed with respect to FIG. 3, any of a variety of systems and/or processes may be utilized in accordance with embodiments of the disclosure. For example, the memory 345 can be an active memory that has the logics loaded/configured and is currently executing the various steps, processes, and/or methods described herein. In some embodiments, the memory 345 may be in a virtual environment such as a cloud-based game administration environment, or it may be distributed across a variety of network devices or servers. The elements depicted in FIG. 3 may also be interchangeable with other elements of FIGS. 1-2 and 4-10 as required to realize a particularly desired embodiment.

Referring to FIG. 4, an abstract block diagram of the data within a storage 318 of a fully controlled camera system in accordance with various embodiments of the disclosure is shown. In many embodiments, environmental data 350 may comprise various sub-types of data like point of interest data 351, environmental dimension data 352, play area data 353, and/or camera location data 354. However, as those skilled in the art will recognize, many other types of data may be included as well depending on the specific game and/or application.

In a number of embodiments, point of interest data 351 can include elements within the game environment that the camera should focus on or highlight. This data can encompass characters, significant objects, and interactive elements that are crucial to the gameplay or narrative. It may also include dynamic events, such as explosions, actions performed by the player or non-player characters, and environmental changes like weather effects. Additionally, point of interest data 351 may take into account contextual cues, such as dialogue or mission objectives, such that the camera may capture the most relevant and engaging aspects of the scene. This data can be formatted in a number of ways but may be a list of coordinates within a three-dimensional space and a corresponding value or score.

In more embodiments, environmental dimension data 352 can be configured as information about the game world's spatial and contextual characteristics. This data may include the size, shape, and layout of various game environments, such as rooms, outdoor areas, and obstacle placements, which helps the camera system navigate and frame scenes effectively. It can also comprise the dynamic elements within the environment, like moving objects, lighting conditions, and weather effects, to adjust camera settings and movements accordingly. Additionally, environmental dimension data 352 may account for interactive elements and potential player actions within these spaces, ensuring that the camera can anticipate and smoothly follow the player's movements while maintaining optimal angles and visibility of key gameplay moments.

In additional embodiments, play area data 353 can comprise various information for determining how a camera may be positioned and moved within the game's environment. This data may also include the spatial dimensions of the game environment where the player may traverse, including, but not limited to, boundaries, obstacles, and key landmarks, which can be utilized to help a camera navigate the environment without clipping through objects or getting obstructed. In certain embodiments, the play area data 353 may also incorporate dynamic elements like the location and movement patterns of characters, enemies, and interactive objects, ensuring they are effectively captured within the frame. Additionally, play area data might include designated points of interest or focal points that the camera should highlight during specific events or actions.

In further embodiments, camera location data 354 may include detailed information about the camera's spatial coordinates within the game environment, its orientation or rotation angles (pitch, yaw, and roll), and its movement vectors. This data can ensure that the camera can dynamically and accurately follow the action, providing optimal viewing angles and perspectives. In certain embodiments, the camera location data 354 may also encompass the camera's distance from the subject, height relative to the ground, and any constraints or boundaries to prevent clipping through objects or environments. Additionally, location data might include predefined waypoints or paths for scripted sequences, ensuring smooth transitions and cinematic shots.

In still more embodiments, player data 360 can include player type data 361 and player movement data 362. Player data 360 may be formatted as a list of attributes or parameters. In some embodiments, the player data 360 be a structure with a set of values that can be interpreted by other logic to implement one or more actions.

In yet further embodiments, player type data 361 may be configured as various attributes and preferences that define the player's or the player's avatar interaction style, skill level, and/or behavior patterns within the game. This data could encompass the player's preferred control settings, such as sensitivity levels for camera movement and specific input configurations. In some embodiments, the player type data 361 may also include information about the player's skill level, which can be inferred from gameplay statistics like reaction times, accuracy, and completion rates. Additionally, player type data 361 could track behavioral patterns, such as tendencies to explore, engage in combat, or focus on story-driven elements.

In still additional embodiments, player movement data 362 can comprise a comprehensive set of information detailing the player's actions and position within the game environment. In certain embodiments, this data may encompass the player's coordinates (X, Y, Z) in a three-dimensional virtual world for example, as well as direction and speed of the movement, and any changes in posture or stance (such as crouching, jumping, or lying prone). It may also include the player's interaction with the environment, such as climbing, swimming, or using objects. Additionally, player movement data 362 may capture or otherwise be modified to reflect input from controllers or keyboards, or other in-game actions.

In many embodiments, camera data 370 may include data related to the virtual camera rendering the game environment, such as, but not limited to, lens data 371, movement data 372, framing data 374, camera type data 375, cameraman data 376, and camera weight data 377. In various embodiments, other factors related to the camera, such as the base score data 373 can reflect a minimum score level for evaluation of a camera by a virtual editor logic.

In a number of embodiments, lens data 371 may comprise several elements that can define how the camera captures the visual scene. This may include the virtual focal length, which determines the field of view and how zoomed in or out the image appears. Aperture settings, which can control the depth of field and the amount of light entering the virtual lens, may also be part of lens data 371. Additionally, it can include information about focus distance, which affects how sharp or blurred objects appear at different distances. Lens data 371 might also capture lens distortion parameters to simulate the curvature or warping effects seen with certain types of lenses.

In more embodiments, movement data 372 can be configured as several components that may dictate how the camera transitions and orients itself in the game environment. This can include the camera's position coordinates (X, Y, Z) relative to the scene, ensuring it can move fluidly to follow the action or adjust perspective. It may also encompass the direction and velocity of the camera's movement, determining how quickly and smoothly it can pan, tilt, or zoom to new viewpoints. Additionally, rotational data can specify the camera's orientation in terms of pitch, yaw, and roll, allowing it to angle correctly and maintain a steady focus on important game elements. This data might also include interpolation methods to ensure smooth transitions between different camera positions and angles, as well as collision detection to prevent the virtual camera from passing through objects.

In additional embodiments, base score data 373 can relate to any initial settings or scores that are assigned to specific cameras. As discussed below, received telemetry data 392 and other update data 383 may require adjustment of the base score data 373 for specific virtual camera points within the game environment. In this way, certain issues can be addressed such as a camera failing to trigger in a fully controlled camera game, or a virtual camera being relied on for too long, which can remove some of the realism of that area of the game.

In further embodiments, framing data 374 may be comprised of several elements that can ensure the visual composition is aesthetically pleasing and functionally effective. In some embodiments, the framing data 374 can include the positioning of primary and secondary subjects within the frame, ensuring that key characters, objects, or actions are properly centered or placed according to various cinematic guidelines. Framing data 374 may also involve determining the appropriate zoom level and field of view to capture necessary details while maintaining contextual awareness of the surroundings. Framing data 374 can also be configured to consider the balance and symmetry of visual elements, managing empty space (negative space) around subjects to avoid cluttered or overly sparse scenes. Additionally, in certain embodiments, framing data 374 can take into account dynamic adjustments, such as re-framing during fast movements or significant scene changes, to keep important elements within the viewer's focus consistently.

In still more embodiments, camera type data 375 can comprise various attributes and settings that may define the specific characteristics and behaviors of the camera being simulated within the game. This can include the camera model, which dictates its physical properties such as size, shape, and weight. It may also encompass the type of lenses that may be used, such as wide-angle, telephoto, or fisheye, which affects the field of view and the degree of distortion. Additionally, in certain embodiments camera type data 375 can include preset configurations for different filming styles, such as stationary, handheld, drone, or Steadicam, each with unique movement and stabilization characteristics. This data may also specify the camera's response to environmental factors like lighting conditions and motion, as well as any built-in effects like zoom capabilities or focus adjustments.

In more further embodiments, cameraman data 376 may include, within the context of a virtual cameraman logic, may be comprised of parameters and attributes that simulate the behavior and decisions of a human camera operator. This data can include predefined movement patterns and styles, such as smooth tracking shots, dynamic panning, or quick zooms, based on the narrative or gameplay requirements. It may also encompass reaction times and sensitivity settings to mimic how a real cameraman would adjust to sudden changes in the scene, such as quick player movements or unexpected events. Additionally, cameraman data 376 can include preferences for framing, such as maintaining a certain distance from the player or focusing on specific elements within the environment as well as sound which can be reflected in additions to the game's sound generated during gameplay.

In still additional embodiments, camera weight data 377 can be associated with information that simulates the physical characteristics and inertia of the virtual camera, contributing to more realistic and dynamic camera movements. This data may include the simulated mass of the camera, which affects how it accelerates, decelerates, and responds to movements or changes in direction. It also encompasses the center of gravity and distribution of weight, which influence the balance and stability of the camera. Additionally, camera weight data 377 may account for the damping and friction parameters, which determine how smoothly the camera transitions between movements and how it handles sudden stops or starts.

In numerous embodiments, scoring data 380 can include various types of data that can affect the scoring of each camera within a gaming environment. This may include, for example, framing score data 381, player preference data 382, and update data 383. However, as those skilled in the art will recognize, other types of scoring data 380 may be utilized as needed.

In a number of embodiments, framing score data 381 may comprise an evaluation and ranking for different camera perspectives based on their effectiveness in framing key elements within the gaming environment. This data can be configured to assess the composition of each shot, ensuring that important subjects, such as the player character, NPCs, and significant objects, are properly positioned according to various cinematic principles like the rule of thirds, balance, focus, etc. An analysis of real-time game scenes can be done to assign scores to various camera angles or camera points based on their ability to highlight crucial action or narrative elements clearly and engagingly.

In more embodiments, player preference data 382 can relate to information tailored to individual player choices and habits, influencing how the camera system adjusts to enhance their gaming experience. This data can include preferred camera angles and perspectives, such as a first-person view, third-person over-the-shoulder view, or top-down perspective. These preferences can be communicated in the form of “hints” such as pushing one or more inputs, etc. The player preference data 382 can also take into account the player's adjustments to camera sensitivity and movement speed, reflecting their comfort level and play style. Additionally, player preference data 382 can capture preferred zoom levels, focus points during different gameplay scenarios (combat, exploration, cutscenes), and any specific settings related to camera behavior, such as automatic panning or manual control options.

In further embodiments, update data 383 can comprise information necessary to keep the camera system and overall game experience current and functioning optimally. This may include patches and bug fixes to address any issues or glitches that have been identified in the camera system or game mechanics. It may also encompass new features and enhancements that improve camera control, such as additional camera angles, improved AI for the virtual cameraman. Furthermore, update data may contain adjustments based on player feedback and telemetry data 392, such as refined camera movement to better match player preferences or optimized performance for different hardware configurations.

In additional embodiments, cinematic data 390 may comprise various data related to how virtual cameras can operate to comport with various photographic and cinematography principles, which can make the game experience seem more realistic and/or more cinematic. In some embodiments, the cinematic data 390 may include heuristic data 391 as well as telemetry data 392.

In still more embodiments, heuristic data 391 may include sets of commands, processes, and/or methods related to various principles that can aide in creating a more realistic and cinematic gaming experience. For example, heuristic data 391 may comprise various “if this, then that” transforms that can indicate when various actions should occur in response to other types of input or game states. In certain embodiments, heuristic data 391 may be formatted as an input into one or more machine learning processes for generation of an inference or output.

In yet further embodiments, telemetry data 392 can be associated with data that has been gathered from play tests or other playthroughs of the game by players. As players play the game, each playthrough may be unique depending on their choices as the player. Over time, this data can be captured in a private (i.e., non-identifying) manner and aggregated into telemetry data 392. This telemetry data 392 can subsequently be utilized to gather insight into the game experience, compare it to a model or desired experience, and generate decisions or update data 383 that can be useful in correcting or otherwise better guiding players through a more optimized game play experience.

The telemetry data 392 can serve as the primary source for configuring the transition timer mentioned in the claims. This data set may specifically contain aggregated player adaptation times, collected from numerous gameplay sessions. When the full control camera logic initiates a transition timer after a cut, it can query the telemetry data 392 to retrieve a relevant historical adaptation time. This value, which may be a global average or a value specific to the player's profile, can then be used to set the duration of the timer. By grounding the timer's duration in actual player behavior data, the system can ensure the delay before establishing the second control scheme is both empirically based and contextually appropriate.

Although a specific embodiment for an abstract block diagram of the data within a storage 318 of a fully controlled camera system suitable for carrying out the various steps, processes, methods, and operations described herein is discussed with respect to FIG. 4, any of a variety of systems and/or processes may be utilized in accordance with embodiments of the disclosure. For example, the data types described herein can vary depending on the type of application deployed and/or desired. For example, each specific data type may be concatenated into one data structure or be broken up into multiple additional data structures. Those skilled in the art will recognize that data can be formatted in a variety of ways beyond the specific embodiment depicted in FIG. 4. The elements depicted in FIG. 4 may also be interchangeable with other elements of FIGS. 1-3 and 5-10 as required to realize a particularly desired embodiment.

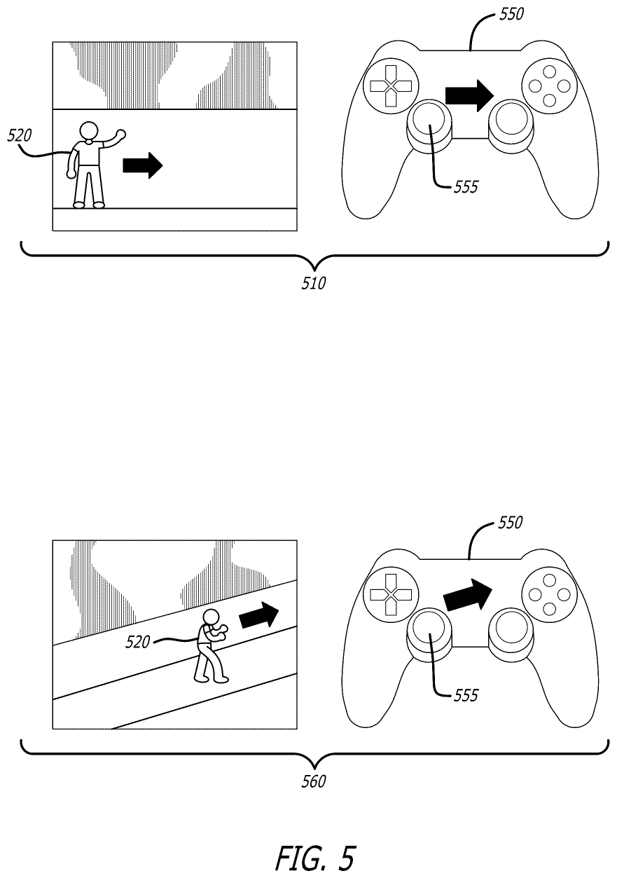

Referring to FIG. 5, a conceptual illustration of automatic relative movement control changes in accordance with various embodiments of the disclosure is shown. In a fully controlled camera system, transitioning between a first control scheme and a second control scheme can involves sophisticated real-time adjustments to ensure seamless and intuitive gameplay. Initially, the first control scheme maps the player's inputs from the controller to movements and actions in the game world. For example, pressing the control stick forward might move the player character forward relative to the camera's current orientation. This control scheme ensures that the player's actions align with their expectations based on the visual feedback from the screen.

When the camera cuts to a second orientation, the system may recalibrate the control inputs to maintain this alignment. This recalibration can involve dynamically adjusting the mapping of the control stick directions to the new camera perspective. In the embodiment depicted in FIG. 5, a first control scheme 510 is applied such that the player's character 520 is moved to the right in response to the player moving or pressing the left control stick 555 of the controller 550 to the right. This control scheme is intuitive as the player's character 520 moves in the same direction as the control stick 555.

However, as the fully controlled camera system conducts a cut within the scene such that a new camera point is selected which has a new orientation, requiring a second control scheme 560. In this control scheme the player must engage the left control stick 555 of the controller 500 in a different manner to get the player's character 520 to keep moving in the same direction. If the player continues to push the left control stick 555 in the same direction under the first control scheme 510, the player's character 520 may not move in the desired direction. As a result, the player must adapt to the transition in control schemes.

In many embodiments, the transition to the second control scheme can be smooth to avoid disorienting the player. The system can continuously track the camera's position and orientation, using algorithms to predict and adjust control inputs accordingly upon a cut in the gameplay. In certain embodiments, if the player is still getting used to this new fully controlled camera system or is otherwise not adjusting quickly, the system may utilize one or more interpolations between the old and new control schemes during the camera cut, providing a seamless experience.

Moreover, the change in control schemes can adapt contextually to different actions and scenarios. For example, in a combat situation, the system can ensure that attacking, dodging, and other maneuvers can remain intuitive or otherwise unchanged despite the camera shift. For example, if the first control scheme involved pressing a button to attack an enemy in front, the second control scheme may adjust this input so that the attack remains directed at the intended target, even if the camera angle changes dramatically.

This adaptive control mechanism can extend to context-sensitive actions as well. Interactions such as picking up items, opening doors, or engaging in dialogue are recalibrated to match the new camera orientation. In some embodiments, the fully controlled camera system may ensure that these actions are still performed intuitively, maintaining consistency and immersion within the game.

Although a specific embodiment for a conceptual illustration of automatic relative movement control changes suitable for carrying out the various steps, processes, methods, and operations described herein is discussed with respect to FIG. 5, any of a variety of systems and/or processes may be utilized in accordance with embodiments of the disclosure. For example, as described below, there may be delays or other verifications done prior to switching the player from the first control scheme to a second controls scheme. The elements depicted in FIG. 5 may also be interchangeable with other elements of FIGS. 1-4 and 6-10 as required to realize a particularly desired embodiment.

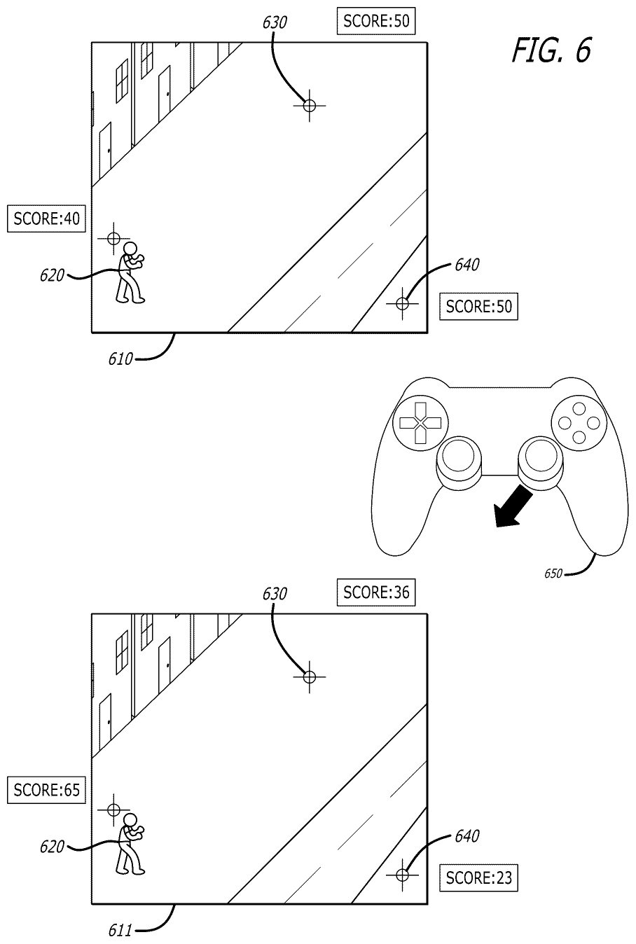

Referring to FIG. 6, a conceptual illustration of utilizing player hints in camera selection weighting in accordance with various embodiments of the disclosure is shown. The embodiment depicted shows a first frame 610 that has a plurality of camera points 630, 640 within the scene. A first camera point is relative to the player, such as an “over-the-shoulder” camera point. The second camera point 630 is at the other end of the frame 610, while the third camera point 640 is across the street. Each camera point in the first frame 610 has an associated score, with the second camera point 630 and third camera point 640 currently leading with a fifty score.

However, the player may utilize a control input, such as the right control stick on a controller 650 to generate a “hint” or otherwise indicate where they would like to look. Specifically in the embodiment shown in FIG. 6, the player is moving the right control stick toward the bottom left. This may or may not correspond to the over-the-shoulder camera point associated with the player 620. In some embodiments this stick movement could indicate the direction of interest, so the game would pick a camera that looks that direction, while in additional embodiments it might pick a camera that is simply in that direction. As a result, and in the example above, the camera score of any camera points closer to the indication can be rated higher, either through a generated weight, or other scaling. Specifically, the second frame 611 after the hint is provided by the player, the over-the-shoulder camera point, which now has a winning score of 65, while the second camera point 630 has a lowered score of thirty-six and the third camera point 640 has a reduced score of twenty-three. Subsequently, the fully controlled camera system can generate cuts as normal, with more chances of a cut going to where the player was indicating.

As described above, scoring camera points based on player hints can be highly beneficial to gameplay as it creates a more personalized and immersive experience by aligning the camera perspective with the player's focus and interests. By integrating player hints, such as, but not limited to, slight adjustments of the control stick towards areas of interest or frequently observed points in the environment, the system can dynamically prioritize and adjust camera angles to highlight these elements. This responsiveness not only enhances the player's engagement by showcasing what they find intriguing or important but also helps in maintaining continuity and reducing disorientation during gameplay. As a result, the game feels more intuitive and player-centric, fostering a deeper connection between the player and the game world.

Although a specific embodiment for a conceptual illustration of utilizing player hints in camera selection weighting suitable for carrying out the various steps, processes, methods, and operations described herein is discussed with respect to FIG. 6, any of a variety of systems and/or processes may be utilized in accordance with embodiments of the disclosure. For example, the hints may be verified (e.g., asking the player to validate the hint, etc.) prior to being utilized in the camera scoring process. The elements depicted in FIG. 6 may also be interchangeable with other elements of FIGS. 1-5 and 7-10 as required to realize a particularly desired embodiment.

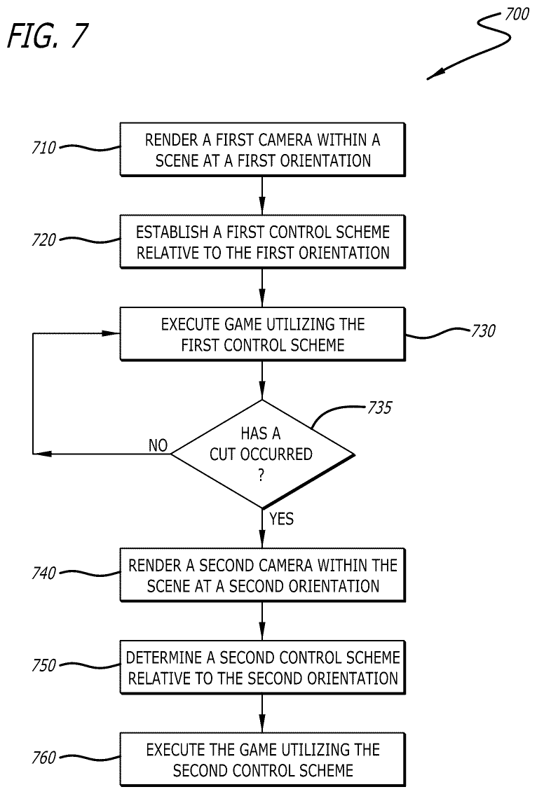

Referring to FIG. 7, a flowchart of a process 700 for utilizing relative control schemes in accordance with various embodiments of the disclosure is shown. In many embodiments, the process 700 can render a first camera within a scene at a first orientation (block 710). In various embodiments, rendering a first camera within a scene at a first orientation can involve initially selecting a camera point based on pre-defined cinematic rules and real-time game data. From a technical perspective, rendering a scene in a game with a camera can involve utilizing the game engine to process the scene's 3D geometry, transforming it into a 2D image from the camera's viewpoint. In various embodiments, this can start by taking the various camera parameters and characteristics into account such as, but not limited to, the camera's position and orientation, field of view, focal length, depth of field, and the like. The game engine may then calculate the visible objects within the camera's frustum (the visible area), applying transformations to project the 3D coordinates of these objects onto a 2D plane. Next, the game engine can apply lighting and shading models, textures and map materials onto the surfaces of objects. Often, rasterization, and post-processing effects may be applied to refine the scene.

In a number of embodiments, the process 700 can establish a first control scheme relative to the first orientation (block 720). In some embodiments, this can involve mapping player inputs from a controller or other input device onto specific in-game actions. More specifically, this can include defining the control layout, where each button, joystick, or trigger on an input device is assigned a particular function, such as movement, attack, jump, interact, etc. For instance, moving the left joystick may control the player's movement direction, while pressing a button might trigger an attack or an action specific to the context of the scene. The game engine is often configured to interpret these inputs in real-time, translating them into corresponding actions on the screen.

In more embodiments, the process 700 can execute the game utilizing the first control scheme (block 730). Executing the game using the established control scheme can involve allowing the player to utilize the controller to navigate and interact with the game world. This execution can continue as needed until an event occurs such as, but not limited to, a level ending, a cutscene, or a cut within the camera system.

In further embodiments, the process 700 can determine if a cut point has occurred (block 735). Various events and scenarios can lead to a “cut point,” where the process 700 can be configured to automatically transition to a different location or angle to enhance the player's experience or transition to a new scene/environment/cutscene, etc. For example, when the player enters a new area or gaming environment, a cut point may occur to provide an optimal overview of the new surroundings, helping the player orient themselves quickly. Significant gameplay moments, such as boss fights, major plot reveals, or important character interactions, might trigger camera cuts to emphasize the event's significance and enhance the narrative impact. During fast-paced action scenes like combat or chase sequences, frequent camera cuts can maintain a dynamic and engaging perspective, ensuring the player has a clear view of the action and any threats.

If a cut has not occurred, then the process 700 can in various embodiments keep executing the game utilizing the first control scheme (block 730). However, if it is determined that a cut has occurred, then additional embodiments of the process 700 can render a second camera within the scene at a second orientation (block 740). In various embodiments, rendering a second camera at a different orientation in a scene can involve several technical steps to ensure a seamless transition and optimal visual output. Upon selection of a second camera point to render a second camera from, the game engine can subsequently recalculate the visible objects within this camera's frustum, updating the 3D geometry and transforming it into a 2D image from the new viewpoint. Other steps, such as lighting, model shading, and texture mapping may also occur accordingly. Rasterization and applying post-processing effects like anti-aliasing and motion blur can also occur to refine the visual output. The transition to this second camera is managed smoothly, often using techniques like cross-fades or match cuts, to maintain continuity and immersion, ensuring that the new camera orientation enhances the player's experience without disrupting gameplay.

In still more embodiments, the process 700 can determine a second control scheme relative to the second orientation (block 750). Determining a second control scheme relative to the second orientation can involve recalibrating player inputs to ensure seamless interaction from the new camera angle. When the camera shifts to the second orientation, the game engine may dynamically adjust the control mapping to maintain intuitive and responsive gameplay. For instance, movement inputs can be recalibrated so that pushing the joystick forward still moves the character in the perceived forward direction from the player's perspective, regardless of the new camera angle. Similarly, directional inputs for actions like aiming or dodging can be reoriented to align with the new view, ensuring that the player's commands correspond accurately to on-screen movements.

In yet further embodiments, the process 700 can execute the game utilizing the second control scheme (block 760). Similar to the discussion above, executing the game using the second control scheme can involve allowing the player to utilize the controller to navigate and interact with the game world relative to the new camera orientation. This execution can continue as needed until another event occurs. In this way, the player can continue to play within a fully controlled camera system, even when cuts are applied to the scene automatically.

In some embodiments, the determination of whether a cut point has occurred (block 735) can be guided by a set of cinematic heuristics stored as cinematic data (390). For instance, the system may be configured to adhere to principles like the 180-degree rule to maintain spatial orientation for the player. A cut may be triggered not only in response to a player entering a new area but also when the virtual editor logic (340) determines that an alternative camera point offers a superior composition or clearer view of the action without creating a jarring jump cut. It is contemplated that the system may continuously score potential camera points, and a cut point can be identified when a new camera point's score exceeds the current one by a predetermined threshold, ensuring that transitions are both meaningful and visually seamless.

Although a specific embodiment for a flowchart of a process 700 for utilizing relative control schemes suitable for carrying out the various steps, processes, methods, and operations described herein is discussed with respect to FIG. 7, any of a variety of systems and/or processes may be utilized in accordance with embodiments of the disclosure. For example, the control scheme may only map certain orientation-based aspects to the various control schemes affected by a change in camera view or other perspective. The elements depicted in FIG. 7 may also be interchangeable with other elements of FIGS. 1-6 and 8-10 as required to realize a particularly desired embodiment.

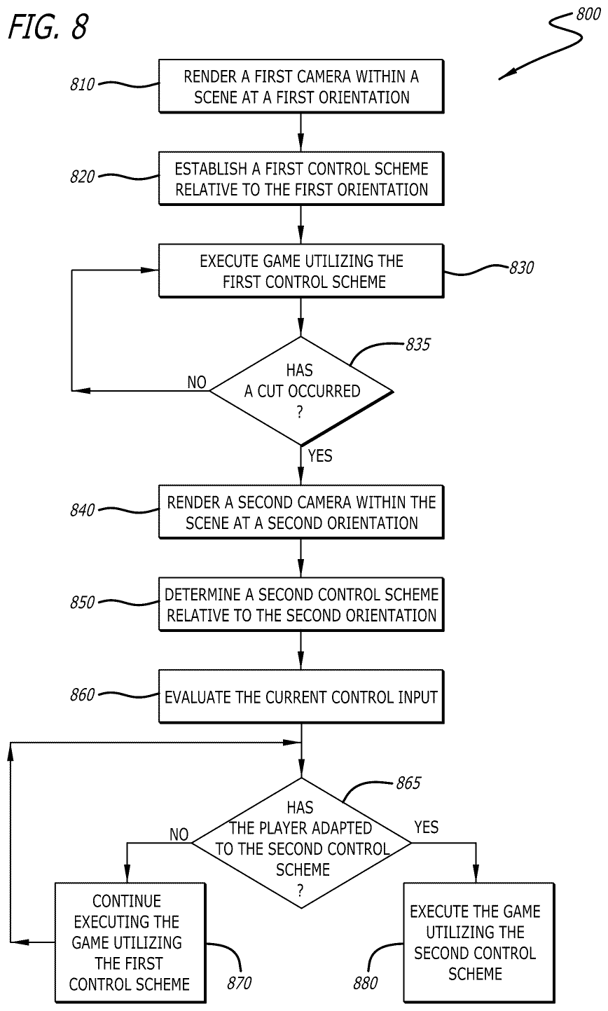

Referring to FIG. 8, a flowchart of a process 800 for adapting a relative control scheme to a player in accordance with various embodiments of the disclosure is shown. In some embodiments, the player may not adapt to a camera cut and change in orientation quickly. For example, during a fight scene, the player may not instantly change pushing the control stick in the correct direction toward the enemy upon a cut. In these instances, various embodiments of the process 800 may wait until the player changes input orientation to apply a secondary control scheme. In many embodiments, the process 800 can render a first camera within a scene at a first orientation (block 810). Similar to above, various embodiments can render a first camera within a scene at a first orientation by selecting a camera point based on pre-defined cinematic rules and real-time game data. From a technical perspective, rendering a scene in a game with a camera can involve utilizing the game engine to process the scene's 3D geometry, transforming it into a 2D image from the camera's viewpoint. In various embodiments, this can start by taking the various camera parameters and characteristics into account such as, but not limited to, the camera's position and orientation, field of view, focal length, depth of field, and the like. The game engine may then calculate the visible objects within the camera's frustum (the visible area), applying transformations to project the 3D coordinates of these objects onto a 2D plane. Next, the game engine can apply processing and post-processing as needed.

In a number of embodiments, the process 800 can establish a first control scheme relative to the first orientation (block 820). In some embodiments, this can involve mapping player inputs from a controller or other input device onto specific in-game actions. More specifically, this can include defining the control layout, where each button, joystick, or trigger on an input device is assigned a particular function, such as movement, attack, jump, interact, etc. For instance, moving the left joystick may control the player's movement direction, while pressing a button might trigger an attack or an action specific to the context of the scene. The game engine is often configured to interpret these inputs in real-time, translating them into corresponding actions on the screen.

In more embodiments, the process 800 can execute the game utilizing the first control scheme (block 830). Executing the game using the established control scheme can involve allowing the player to utilize the controller to navigate and interact with the game world. This execution can continue as needed until an event occurs such as, but not limited to, a level ending, a cutscene, or a cut within the camera system.

In further embodiments, the process 800 can determine if a cut has occurred (block 835). Various events and scenarios can lead to a “cut point,” where the process 800 can be configured to automatically transition to a different location or angle to enhance the player's experience or transition to a new scene/environment/cutscene, etc. For example, when the player enters a new area or gaming environment, a cut point may occur to provide an optimal overview of the new surroundings, helping the player orient themselves quickly. Significant gameplay moments, such as boss fights, major plot reveals, or important character interactions, might trigger camera cuts to emphasize the event's significance and enhance the narrative impact. During fast-paced action scenes like combat or chase sequences, frequent camera cuts can maintain a dynamic and engaging perspective, ensuring the player has a clear view of the action and any threats.

If a cut has not occurred, then the process 800 can in various embodiments keep executing the game utilizing the first control scheme (block 830). However, if it is determined that a cut has occurred, then additional embodiments of the process 800 can render a second camera within the scene at a second orientation (block 840). In various embodiments, rendering a second camera at a different orientation in a scene can involve several technical steps to ensure a seamless transition and optimal visual output. Upon selection of a second camera point to render a second camera from, the game engine can subsequently recalculate the visible objects within this camera's frustum, updating the 3D geometry and transforming it into a 2D image from the new viewpoint. Other steps, such as lighting, model shading, and texture mapping may also occur accordingly. Rasterization and applying post-processing effects like anti-aliasing and motion blur can also occur to refine the visual output. The transition to this second camera is managed smoothly, often using techniques like cross-fades or match cuts, to maintain continuity and immersion, ensuring that the new camera orientation enhances the player's experience without disrupting gameplay.

In various embodiments, after rendering a second camera at a new orientation (block 840), the system may provide sensory feedback to the player to signal the impending control scheme change. For example, the system could generate a subtle visual cue on the user interface or trigger a brief haptic response on the player's controller. This feedback can serve as a non-intrusive alert, helping the player to more quickly and consciously adapt their inputs to the new relative orientation. In another embodiment, the intensity or type of feedback could vary based on the context of the gameplay. For instance, a more pronounced cue might be used during low intensity exploration scenes, while a more subtle cue could be used during fast paced combat to avoid distracting the player.

In still more embodiments, the process 800 can determine a second control scheme relative to the second orientation (block 850). Determining a second control scheme relative to the second orientation can involve recalibrating player inputs to ensure seamless interaction from the new camera angle. When the camera shifts to the second orientation, the game engine may dynamically adjust the control mapping to maintain intuitive and responsive gameplay. For instance, movement inputs can be recalibrated so that pushing the joystick forward still moves the character in the perceived forward direction from the player's perspective, regardless of the new camera angle. Similarly, directional inputs for actions like aiming or dodging can be reoriented to align with the new view, ensuring that the player's commands correspond accurately to on-screen movements.

In yet further embodiments, the process 800 can evaluate the current control input (block 860). The evaluation can be done by polling or reading the input data coming in from one or more input devices, such as but not limited to, a player controller. For example, each button press can be passed to the process 800 for evaluation.

In still additional embodiments, the process 800 can determine if the player has adapted to the second control scheme (block 865). As previously discussed, a player may not instantly change their relative movement when a camera changes. In order to facilitate a smoother gameplay experience, the process 800 may compare the current input values against the updated second control scheme values. For example, if a player continues to press a control stick in the same direction that they were doing before the cut, even after the cut is made, the process 800 may interpret that as the player not adapting to the change in relative control schemes.

If it is determined that the player has not adapted to the second control scheme, various embodiments of the process 800 can continue executing the game utilizing the first control scheme (block 870). In certain embodiments, the process 800 may desire to provide a seamless gameplay experience to the player, even if they have not immediately adjusted to a new, second control scheme. In these instances, the process 800 can still apply the input movements from the first control scheme to the new orientation, such that a translation is done automatically between control schemes. In this way, the player may not be penalized for not instantly changing with the cut in action of the fully controlled camera system.

However, if it is determined that the player has adapted to the second control scheme, then certain embodiments of the process 800 can execute the game utilizing the second control scheme (block 880). At some point during gameplay after a cut, the player can realize that the relative orientation has changed and that a new set of inputs should be used to yield the same desired results from the first control scheme. For example, the player may start to change the direction of movement from a direction that was valid under the first control scheme to a new direction that yields the same result under the second control scheme. Upon detecting that this change has occurred in player input, various embodiments of the process 800 can adjust or otherwise apply the second control scheme. In additional embodiments, the process 800 may simply stop translating the inputs from the first control scheme to the second control scheme.

Although a specific embodiment for a flowchart of a process 800 for adapting a relative control scheme to a player suitable for carrying out the various steps, processes, methods, and operations described herein is discussed with respect to FIG. 8, any of a variety of systems and/or processes may be utilized in accordance with embodiments of the disclosure. For example, in some embodiments, the process 800 may use contextual clues to force a player to change control schemes. In these instances, less action may be occurring such that a slight change in outcomes in the second control scheme does not negatively affect the player sufficiently. Thus, the player can be quickly given a feedback or indication that the control scheme has changed. The elements depicted in FIG. 8 may also be interchangeable with other elements of FIGS. 1-7 and 9-10 as required to realize a particularly desired embodiment.

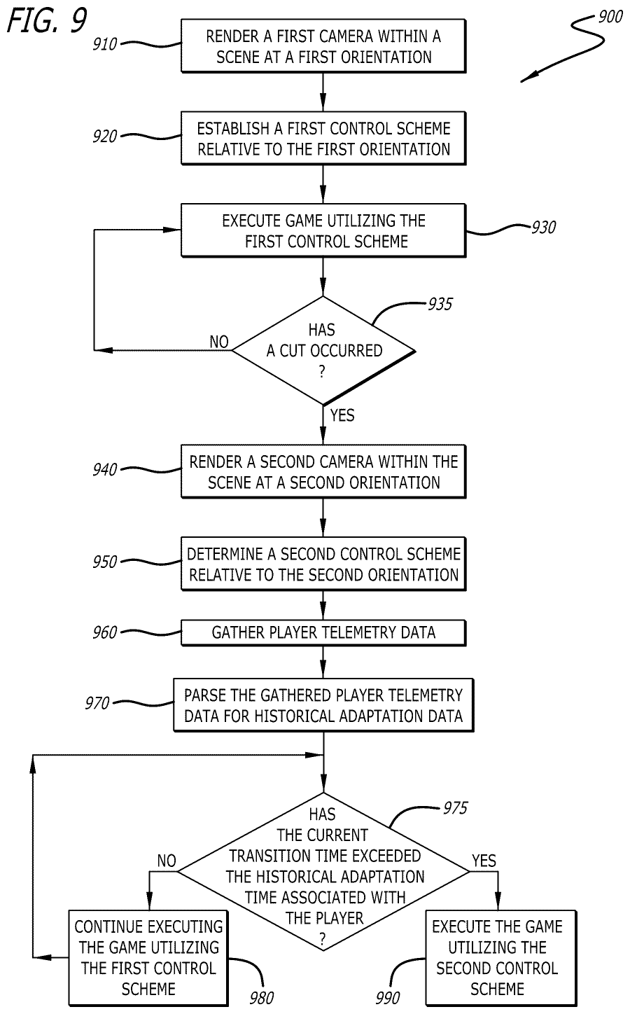

Referring to FIG. 9, a flowchart of a process 900 for utilizing telemetry data in a relative control scheme in accordance with various embodiments of the disclosure is shown. While some embodiments may monitor player inputs to determine changes in control schemes, additional embodiments may utilize past player data, such as telemetry data that can indicate when a good time to change control schemes may occur. In many embodiments, the process 900 can render a first camera within a scene at a first orientation (block 910). In various embodiments, rendering a first camera within a scene at a first orientation can involve initially selecting a camera point based on pre-defined cinematic rules and real-time game data. From a technical perspective, rendering a scene in a game with a camera can involve utilizing the game engine to process the scene's 3D geometry, transforming it into a 2D image from the camera's viewpoint.

In various embodiments, this can start by taking the various camera parameters and characteristics into account such as, but not limited to, the camera's position and orientation, field of view, focal length, depth of field, and the like. The game engine may then calculate the visible objects within the camera's frustum (the visible area), applying transformations to project the 3D coordinates of these objects onto a 2D plane. Next, the game engine can apply lighting and shading models, textures and map materials onto the surfaces of objects. Often, rasterization, and post-processing effects may be applied to refine the scene.

In a number of embodiments, the process 900 can establish a first control scheme relative to the first orientation (block 920). In some embodiments, this can involve mapping player inputs from a controller or other input device onto specific in-game actions. More specifically, this can include defining the control layout, where each button, joystick, or trigger on an input device is assigned a particular function, such as movement, attack, jump, interact, etc. For instance, moving the left joystick may control the player's movement direction, while pressing a button might trigger an attack or an action specific to the context of the scene. The game engine is often configured to interpret these inputs in real-time, translating them into corresponding actions on the screen.

In more embodiments, the process 900 can execute the game utilizing the first control scheme (block 930). Executing the game using the established control scheme can involve allowing the player to utilize the controller to navigate and interact with the game world. This execution can continue as needed until an event occurs such as, but not limited to, a level ending, a cutscene, or a cut within the camera system.

In further embodiments, the process 900 can determine if a cut has occurred (block 935). Various events and scenarios can lead to a “cut point,” where the process 900 can be configured to automatically transition to a different location or angle to enhance the player's experience or transition to a new scene/environment/cutscene, etc. For example, when the player enters a new area or gaming environment, a cut point may occur to provide an optimal overview of the new surroundings, helping the player orient themselves quickly. Significant gameplay moments, such as boss fights, major plot reveals, or important character interactions, might trigger camera cuts to emphasize the event's significance and enhance the narrative impact. During fast-paced action scenes like combat or chase sequences, frequent camera cuts can maintain a dynamic and engaging perspective, ensuring the player has a clear view of the action and any threats.

If a cut has not occurred, then the process 900 can in various embodiments keep executing the game utilizing the first control scheme (block 930). However, if it is determined that a cut has occurred, then additional embodiments of the process 900 can render a second camera within the scene at a second orientation (block 940). In various embodiments, rendering a second camera at a different orientation in a scene can involve several technical steps to ensure a seamless transition and optimal visual output. Upon selection of a second camera point to render a second camera from, the game engine can subsequently recalculate the visible objects within this camera's frustum, updating the 3D geometry and transforming it into a 2D image from the new viewpoint. Other steps, such as lighting, model shading, and texture mapping may also occur accordingly. Rasterization and applying post-processing effects like anti-aliasing and motion blur can also occur to refine the visual output. The transition to this second camera is managed smoothly, often using techniques like cross-fades or match cuts, to maintain continuity and immersion, ensuring that the new camera orientation enhances the player's experience without disrupting gameplay.

In still more embodiments, the process 900 can determine a second control scheme relative to the second orientation (block 950). Determining a second control scheme relative to the second orientation can involve recalibrating player inputs to ensure seamless interaction from the new camera angle. When the camera shifts to the second orientation, the game engine may dynamically adjust the control mapping to maintain intuitive and responsive gameplay. For instance, movement inputs can be recalibrated so that pushing the joystick forward still moves the character in the perceived forward direction from the player's perspective, regardless of the new camera angle. Similarly, directional inputs for actions like aiming or dodging can be reoriented to align with the new view, ensuring that the player's commands correspond accurately to on-screen movements.

In yet further embodiments, the process 900 can gather player telemetry data (block 960). As games are released and played by various players, telemetry data may be generated that gathers and otherwise indicates data related to various playthroughs done by players. In this way, the telemetry data can be used to update the game as desired by the game designers. For example, the telemetry data may indicate that players largely take a certain amount of time when changing from one type of cut to another. Utilizing this telemetry data, specific lag timings can be deployed such that more players are able to more seamlessly play the game through the fully controlled camera system. In some embodiments, the telemetry data may be aggregated to generate a consensus or generalized value. However, in certain embodiments, the telemetry data may be configured for each individual player.

In still additional embodiments, the process 900 can parse the gathered player telemetry data for historical adaptation data (block 970). Telemetry data may be comprised of a number of different types of data that all relate to how a player has played through a game. In some embodiments, the telemetry data may comprise historical adaptation data that can be associated with, for example, how long a player typically takes to adjust from a first control scheme to a second control scheme after a fully automated cut within a scene. In various embodiments, this may include granular details such as, but not limited to, the historical transition times from one type of cut or camera point to another, or even from one specific camera point to another specific camera point.

The process of parsing player telemetry data for historical adaptation data (block 970) can, in certain embodiments, be augmented by one or more machine learning models (226). Instead of relying on a simple average of past adaptation times, a trained machine learning model could generate a predictive inference for the player's adaptation time based on a richer set of inputs. It is contemplated that the model may analyze not only the player's historical data but also the current game state, such as the complexity of the environment, the number of enemies on screen, and the speed of the player's character. For instance, the model might predict a shorter adaptation time during a simple traversal and a longer one during a chaotic boss fight, allowing for a more dynamically adjusted and context aware transition timer.

In a variety of embodiments, the process 900 can determine if the current transition time has exceeded the historical adaptation time associated with the player (block 975). Based on the parsed historical adaptation time, the process 900 may, in certain embodiments, simply not attempt a transition from the first control scheme to the second control scheme until that time amount has passed. The historical transition time may be a value specific to that player, or may be a general or average value derived from an aggregated source of telemetry data.

If it is determined that the current transition time has not exceeded the historical adaptation time, then certain embodiments of the process 900 can continue or otherwise revert to executing the game utilizing the first control scheme (block 980). As described above, certain embodiments of the process 900 may desire to provide a seamless gameplay experience to the player, even if they have not immediately adjusted to a new, second control scheme. In these instances, the process 900 can still apply the input movements from the first control scheme to the new orientation, such that a translation is done automatically between control schemes. In this way, the player may not be penalized for not instantly changing with the cut in action of the fully controlled camera system. This can lead to the process 900 re-determining if the timer has elapsed (or in some cases if the player has adjusted) until it is time to execute the second control scheme.

However, if it is determined that the current transition time has exceeded the historical transition time, then some embodiments of the process 900 can execute the game utilizing the second control scheme (block 990). As the historical adaptation time expires, it can be assumed by the process 900 that the player has or will shortly adjust to the relative orientation change and that a new set of inputs should be used to yield the same desired results from the first control scheme. Upon detecting that the historical adaptation time has elapsed, various embodiments of the process 900 can adjust or otherwise apply the second control scheme. In additional embodiments, the process 900 may simply stop translating the inputs from the first control scheme to the second control scheme.

Although a specific embodiment for a flowchart of a process 900 for utilizing telemetry data in a relative control scheme suitable for carrying out the various steps, processes, methods, and operations described herein is discussed with respect to FIG. 9, any of a variety of systems and/or processes may be utilized in accordance with embodiments of the disclosure. For example, in some embodiments, the process 900 may attempt to decrease the historical transition time value such that a player may be “trained” to respond faster in the future. The elements depicted in FIG. 9 may also be interchangeable with other elements of FIGS. 1-8 and 10 as required to realize a particularly desired embodiment.

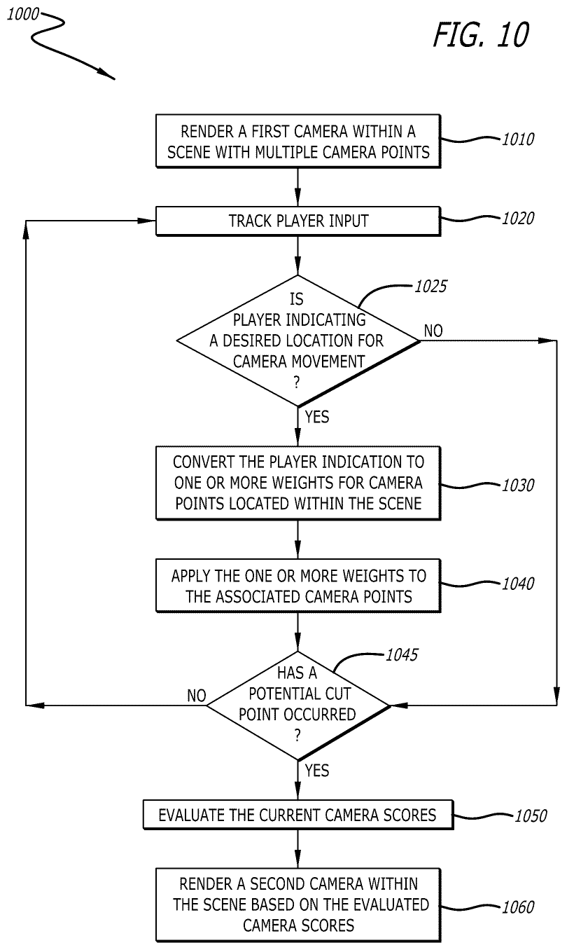

Referring to FIG. 10, a flowchart of a process 1000 for utilizing player hints for camera score weighting in accordance with various embodiments of the disclosure is shown. Even in a fully controlled camera system, there may be instances where a player may want a change in the camera, such as to look in a specific area or at some item in the environment they believe is important. As such, a method of providing hints from the player may be utilized to color the scoring of different camera points such that cuts to camera points associated with the intent of the player can occur.

In many embodiments, the process 1000 can render a first camera within a scene with multiple camera points (block 1010). As previously discussed, each scene in an environment may have multiple locations where a camera can be placed, or camera points. The number of available camera points can vary based on the environment and other factors such as obstacles, players, enemies, and the like. Each camera point may be cut to by the fully controlled camera system in response to various factors such as, but not limited to, a change in score or one or more cut point events.

In a number of embodiments, the process 1000 can track player input (block 1020). This tracking can be done by polling or reading the input data coming in from one or more input devices, such as but not limited to, a player controller. For example, each button press can be passed to the process 1000 for evaluation.

In more embodiments, the process 1000 can determine if the player is indicating a desired location for camera movement (block 1025). As those skilled in the art will recognize, various methods can be used to track a player's desire and indications. For example, a controller may have a secondary control stick that can be utilized by the player to indicate where they would like to look. In additional embodiments, the indications can be derived from monitoring the player activity, such as continued movement towards and area or over an item, or when a group of players are all standing in the same location in the environment. Other methods are contemplated, and the examples given here are illustrative in nature and not meant to be comprehensive.

If it is determined that no player indication is being received, then various embodiments of the process 1000 can further determine if a potential cut has occurred (block 1045). Various events and scenarios can lead to a “cut point,” where the process 1000 can be configured to automatically transition to a different location or angle to enhance the player's experience or transition to a new scene/environment/cutscene, etc. For example, when the player provides a hint, enters a new area or gaming environment, a cut point may occur to provide an optimal overview of the new surroundings, helping the player orient themselves quickly.

However, if it is determined that the player is indicating a desired location for camera movement, then certain embodiments of the process 1000 can convert the player indication to one or more weights for camera points located within the scene (block 1030). As described above, the hints or indications provided by the player(s) can be converted into one or more weights or a scale conversion for a final camera score. The specific conversion or value derived can vary based on a variety of factors including, but not limited to, the type of camera being indicated toward, the specific game environment, the current game state, etc. For example, hints may not affect camera score as much during action scenes compared to non-action scenes.

In further embodiments, before converting a player indication to one or more weights (block 1030), the system can first validate the player's input to ensure it represents a deliberate hint. This validation process can prevent accidental or fleeting controller movements from unintentionally influencing the camera scoring. For example, the system might require the input, such as a movement of a control stick, to be held in a specific direction for a minimum duration, such as 250 milliseconds, before it is registered as a valid hint. It is also contemplated that the system could analyze the consistency of the input over time. An erratic or quickly changing input might be disregarded as noise, while a sustained and steady directional input would be confirmed as an intentional hint from the player.

In further embodiments, the process 1000 can apply the one or more weights to the associated camera points (block 1040). Applying these weights or other scales/offsets to the camera scores can be done after a non-hint camera score is generated. However, in certain embodiments, the adjustments may be “baked in” and affect the camera score generation process such that the final score is affected, and the fully controlled camera system is allowed to otherwise process cuts as usual.

Again, in some embodiments, the process 1000 can determine if potential cut point has occurred (block 1045). If it is determined that no potential cut point has occurred, some embodiments of the process 1000 can continue to track player input (block 1020). However, if it is determined that a potential cut point has occurred or will occur in the near future, a variety of embodiments of the process 1000 can evaluated the current camera scores (block 1050). This step in the process 1000 can occur normally in various embodiments.

In still more embodiments, the process 1000 can render a second camera within the scene based on the evaluated camera scores (block 1060). In various embodiments, rendering a second camera at a different orientation in a scene can involve several technical steps to ensure a seamless transition and optimal visual output. Upon selection of a second camera point to render a second camera from, the game engine can subsequently recalculate the visible objects within this camera's frustum, updating the 3D geometry and transforming it into a 2D image from the new viewpoint. Other steps, such as lighting, model shading, and texture mapping may also occur accordingly. Rasterization and applying post-processing effects like anti-aliasing and motion blur can also occur to refine the visual output. The transition to this second camera is managed smoothly, often using techniques like cross-fades or match cuts, to maintain continuity and immersion, ensuring that the new camera orientation enhances the player's experience without disrupting gameplay, while allowing the player to have a better change to influence the camera selection and allow them to “see”what they were previously hinting at.

Although a specific embodiment for a flowchart of a process 1000 for utilizing player hints for camera score weighting suitable for carrying out the various steps, processes, methods, and operations described herein is discussed with respect to FIG. 10, any of a variety of systems and/or processes may be utilized in accordance with embodiments of the disclosure. For example, the hints may be scored or scaled based on telemetry data. In these embodiments, a player that indicates a hint for one area or item that has also been indicated by other players in the telemetry data may yield a bigger scaled score or weight within the fully controlled camera system and corresponding camera score process. Conversely, indications made by a player that have not been done by other players in the telemetry data can yield a lower effect within the camera score system. The elements depicted in FIG. 10 may also be interchangeable with other elements of FIG. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more. ” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
a full control camera logic, stored in the memory and executed by the processor, configured to:
render a first camera within a scene of an interactive environment at a first orientation;
establish a first control scheme relative to the first orientation;
determine if a cut within the scene has occurred;
render, upon determining that a cut has occurred, a second camera within the scene at a second orientation; and
establish a second control scheme relative to the second orientation.

2. The device of claim 1, wherein the interactive environment is a video game environment.

3. The device of claim 2, wherein the scene is a unique portion of the video game environment.

4. The device of claim 3, wherein the full control camera logic is further configured to execute the video game environment upon establishing the first control scheme.

5. The device of claim 4, wherein the full control camera logic is further configured to execute the video game environment upon establishing the second control scheme.

6. The device of claim 5, wherein the full control camera logic is further configured to evaluate player input after establishing the second control scheme.

7. The device of claim 6, wherein the full control camera logic is further configured to determine if the evaluated player input indicates if a player has adapted to the second control scheme.

8. The device of claim 7, wherein the full control camera logic is further configured to continue, upon determining that the player has adapted to the second control scheme, the second control scheme.

9. The device of claim 7, wherein the full control camera logic is further configured to revert, upon determining that the player has not adapted to the second control scheme, to the first control scheme.

10. The device of claim 9, wherein the full control camera logic is further configured to re-determine if the evaluated player input indicates if a player has adapted to the second control scheme until an adaptation has occurred.

11. The device of claim 10, wherein the full control camera logic is further configured to execute the video game environment utilizing the second control scheme upon adaptation.

12. A device, comprising:
a processor;
a memory communicatively coupled to the processor; and
a full control camera logic, stored in the memory and executed by the processor, configured to:
render a first camera within a scene of an interactive environment at a first orientation;
establish a first control scheme relative to the first orientation;
determine if a cut within the scene has occurred;
render, upon determining that a cut has occurred, a second camera within the scene at a second orientation;
initiate a transition timer; and
establish, upon expiration of the transition timer, a second control scheme relative to the second orientation.

13. The device of claim 12, wherein the full control camera logic is further configured to gather player data.

14. The device of claim 13 wherein the full control camera logic is further configured to parse player data to determine a historical adaptation time.

15. The device of claim 14, wherein the transition timer is configured based on at least the historical adaptation time.

16. A method of establishing control schemes within an interactive environment, comprising:
rendering a first camera within a scene of the interactive environment at a first orientation;
establishing a first control scheme relative to the first orientation;
determining if a cut within the scene has occurred;
rendering, upon determining that a cut has occurred, a second camera within the scene at a second orientation; and
establishing a second control scheme relative to the second orientation.

17. The method of claim 16, wherein the interactive environment is a video game environment.

18. The method of claim 17, wherein the scene is a unique portions of the video game environment.

19. The method of claim 18, wherein the method further comprises executing the video game environment upon establishing the first control scheme.

20. The method of claim 19, wherein the method further comprises executing the video game environment upon establishing the second control scheme.
